(19) United States
(12) Patent Application Publication
(10) Pub. No.: US 2003/0108274 A1
(43) Pub. Date: Jun. 12, 2003

(54) Mode coupled optomechanical devices

(76) Inventor: Dan Haronian, Jerusalem (IL)

Correspondence Address: LADAS & PARRY, 26 WEST 61ST STREET, NEW YORK, NY, 10023, US

(21) Appl. No.: 10/111,181

(22) PCT Filed: Aug. 22, 2001
(86) PCT No.: PCT/IL01/00787

(30) Foreign Application Priority Data
Aug. 22, 2000 (IL) 138014

(51) Int. Cl. G02B 6/35; G02B 6/26; G02B 6/293

(52) U.S. Cl. 385/17; 385/16; 385/50; 385/24

(57) ABSTRACT

An optomechanical device, based on mode coupling, and methods for its use. Two waveguides cross each other and a movable suspended coupler is located at the cross-over, such that on activation, the light propagating in one of the waveguides is coupled into the second waveguide. The coupler may be a third waveguide that upon in-plane deflection, is brought into close proximity or to contact with the sides of the two waveguides. This action creates an optical path by means of the evanescent fields of the two waveguides and the coupling waveguide itself. This basic building block creates a 1 to 1 switching unit that can be scaled up to form non-blocking matrices of ‘n’ input waveguides by ‘m’ output waveguides. Applications for Wavelength Add and Drop Systems, and for Gain Equalizer Systems are described.

### FIELD OF THE INVENTION

The present invention relates to the field of optical switches and, more particularly, to optical switches based on mode coupling, and their device applications.

### BACKGROUND OF THE INVENTION

Integrated optical switches are important devices used as high speed switching elements in many integrated optical communication systems, and other opto-electronic systems. There currently exist a number of different types of such switches. Integrated optomechanical switches are known, in which optical waveguides are fabricated as part of an integrated micro-mechanical structure. Examples of this technology in the prior art are given in the article by E. Ollier et al. entitled “Micro-opto mechanical switch integrated on silicon”, published in Electronics Letters Vol. 31 No. 23 pp. 2003-2005 (1995); in that by E. Ollier et al., entitled “Integrated electrostatic micro-switch for optical fiber networks driven by low voltage”, published in Electronics Letters, Vol. 32 No. 21, (1996), and in U.S. Pat. No. 5,612,815, to Labeye et al. All of the above-mentioned documents are hereby incorporated by reference, each in its entirety.

These devices all employ mechanical displacement to shift between states in which an input waveguide is aligned alternately with different output waveguides. Such displacement must be at least equal to the cross sectional dimensions of the waveguides, and typically significantly larger. Such a geometry has a serious disadvantage in that losses at the switch are comparatively high, thus limiting the scalability of the switches to small network use. Furthermore, the switching displacement in this geometry is of such a large comparative size that the maximum response speed of the switch is limited. In addition, with such large displacements, the possibility exists of misalignment between the input and output waveguides.

Another switching technology is based on the use of tilting micro-mirrors. In this case, micro-mirrors formed on a silicon wafer are used to redirect light from input fibers to output fibers, such as is described by L. Y. Lin, et al, in the article entitled “Free-Space Micromachined Optical Switches for Optical Networking”, published in IEEE Journal of Selected Topics in Quantum Electronics, Vol. 5, No. 1, January/February 1999, pp. 4-9.

Yet another technique is presented by F. Chollet, et al., in the article “Compact Evanescent Optical Switch and Attenuator with Electromechanical Actuation”, published in IEEE Journal of Selected Topics in Quantum Electronics, Vol. 5, No. 1, January/February 1999, pp. 52-59. In this paper, there is described how a suspended waveguide is positioned above a second waveguide and upon being deflected out of plane, is brought into contact with the second waveguide. When contact has been made, light is coupled from the first waveguide to the second waveguide by means of the mode coupling. This technology has a distinct disadvantage in that it is based on an out of plane movement. As will be explained below, the need for such a movement limits the degree of complexity of the device that can be fabricated. In particular, the incorporation of out of plane motion does not allow simple network formation of more than 2×2. Furthermore, even such a simple 2×2 switch network would probably have an unacceptable level of crosstalk.

Planarity is a fundamental property of microfabrication technology. It is their planar nature that allows different elements in VLSI, such as diodes, transistors, capacitors etc., to be placed and to interact on the wafer. The property of planarity is utilized in Micro-Electro Mechanical System (NEMS) technology, and many MEMS are comprised of elements such as sensors and actuators that are fabricated and interact in the plane of the wafer, and thus have an in-plane Degree Of Freedom (DOF). Some examples of such in-plane systems are the micro x-y-z stage carrying an Scanning Tunneling Microscope (STM) tip, by Xu Y, et al., in the article “Integrated micro-scanning tunneling microscope” published in Applied Physics Letters, Vol. 67, pp. 2305-2307 (1995), the vibrating gyroscope, described by K. Maenaka et al in the article “Analysis of a highly sensitive silicon gyroscope with cantilever beam as a vibrating mass”, published in Sensors and Actuators Vol. A54, pp. 568-573, (1996), or the micro-gear described by R. Legtenberg et al, in the article “A fabrication process for electrostatic microactuator with integrated gear linkages” published in Journal of Microelectromechanical Systems, Vol. 6, pp. 234-241 (1997). All of the above articles describe MEMS with several mechanical components interacting with each other in the plane of the wafer.

In-spite of the planar nature of microelectronic devices, MEMS with an out-of-plane DOF have been reported. Some such examples are a micromachined microphone made of a suspended membrane over a sealed cavity, described by N. Yazdi et al., in the article “An all-silicon single-wafer fabrication technology for precision micro-accelerometer” which appears in the Technical Digest of the 9th International Conference on Solid-state Sensors and Actuators (Transducers '97), Chicago Ill., pp 1181-1184 (1997), and the pendulum accelerometer fabricated using wet etched silicon, described by J. Bergqvist et al., in the article “A silicon condenser microphone using bond and etch-back technology” published in Sensors and Actuators, Vol. A45, pp. 115-124, (1994). However, because of the planar nature of the microfabrication technology, these MEMS have low mechanical integration abilities, and therefore are capable of performing only simple tasks. The optical switch described by F. Chollet et., al. (op. cit.) also uses an out-of-plane DOF and therefore is thus limited when applied for use in large networks. In particular, commonly used switching network architecture cannot be implemented by using out of plane DOF.

In spite of the inherent advantages in the construction and integration of in-plane DOF devices, as explained above, there is one aspect of their structure which complicates their efficient operation for optical switching. In such structures, there is necessity to use passage of light across essentially vertical side walls of fabricated structures. Such vertical side walls are produced by deep reactive ion etching (DRIE), and the surface roughness and the side-wall verticality obtained by this process may be insufficient for high efficiency optical applications. With out-of-plane DOF devices, on the other hand, the optical contact and transfer surfaces are fabricated by conventional planar deposition processes which are typically of high optical quality and that can be readily improved by conventional CMP methods.

There therefore exists a need for an optical switch that is based on in-plane DOF's only, so that that the fabrication of large switching networks using that technology is enabled. It would also be highly advantageous to provide an integrated optomechanical implementation of such a switch. In addition the basic switch building block should be capable of being scaled up to form large networks. Furthermore, methods of producing such structures with good side wall accuracy and smoothness are necessary for implementing such devices.

The disclosures of each of the publications mentioned in this section and in other sections of the specification, are hereby incorporated by reference, each in its entirety.

### SUMMARY OF THE INVENTION

The present invention seeks to provide a new optomechanical switching device based on mode coupling, and methods for its use. According to coupled mode theory, when two waveguides are in close proximity, they become electromagnetically coupled such that light is gradually transferred from one waveguide to the other. For such coupled waveguides, the length in which effectively all the light is transferred from one waveguide to the second waveguide is known as the coupling length.

There is thus provided, in accordance with a preferred embodiment of the present invention, a switching device made up of two waveguides with a coupler in close proximity to the waveguides. The coupler is preferably suspended such that when a force is applied to it, it moves closer and touches the two waveguides such that light propagating along one of the waveguides is coupled into the second waveguide. According to one preferred embodiment of the present invention, such a structure may be implemented by fabricating the two waveguides such that they cross each other, and by forming the coupling wave guide with a curve such that one end of the coupler is parallel and close to one waveguide and the other end is parallel to the second waveguide. The coupler is preferably suspended on a spring that is connected to a microactuator such that when the actuator moves, it brings the coupling waveguide into closer proximity or into contact with the two waveguides. The light from one waveguide is coupled into the coupler and from there to the second waveguide by means of mode coupling. The light is preferably delivered to the first waveguide from an input fiber and is sent by the second waveguide to an output fiber. This therefore establishes a 1 to 1 optical switch. Using this basic switch building block, it is possible to build a one dimension array of ‘n’ input waveguides (for convenience in explaining the invention, generally referred to in this application as the “horizontal waveguides”) and another one dimension array of ‘m’ output waveguides (vertical waveguides) such that the two arrays cross each other to form a mesh. At each crossing point a coupler is disposed to couple light propagating in the nearby horizontal waveguide into the vertical waveguide. This configuration forms an n×m optical switching network. Though the invention is explained throughout this application using the terms horizontal and vertical to represent the input and output waveguides respectively, it is to be understood that these terms are purely relative, used for convenience in explaining the invention, and that their roles could be reversed, or even named otherwise.

The waveguide forming the single switch or the network can preferably be silicon, and the light signals switched in such a medium are preferably of wavelength between 1.3 microns and 1.6 microns. At these wavelengths, silicon has an index of refraction of 3.5. It should however be noted that different integrated implementations of the devices and methods of the present invention may be achieved, using a range of generally known waveguide structures and fabrication techniques. Preferred examples for waveguide structures include, but are not limited to, silicon-based chips with waveguides formed from silicon-on-insulator (SOI), silicon nitride, or through ion implantation. In addition, the invention can preferably be constructed and applied in ribbed waveguide, which allows a large cross section but supports only the first mode. The coupling between the two waveguides can preferably be enhanced by using a coupling grating. This may reduce the coupling length required and therefore the dimension of the network. This coupling may also be enhanced by shaping the waveguide and/or the coupling waveguides. This shaping can be fixed, for example, by creating an adiabatic transition such that when the coupling beam is in contact with the adiabatic section, light is coupled more efficiently into it. Another way to increase the coupling efficiency, according to another preferred embodiment of the present invention, is by suspending both the coupler and the waveguide, and by creating a deformation when these two waveguides touch each other. Such a deformation can increase the coupling efficiency, since at the bending point of the waveguide, light leaks with increased efficiency into the coupling waveguide.

As noted above the waveguides can be formed from SOI wafers such that the horizontal and vertical waveguides cross each other on the same plane. According to another more preferred embodiment of the present invention, the waveguides are formed on different layers. This reduces the cross talk between the horizontal and vertical waveguides and reduces the losses along these waveguides arising from scattering at the crossing point. This type of network can preferably be implemented by using double waveguiding layers that are isolated from each other by a layer of insulating material having a lower index of refraction than the waveguide itself. One preferred way of doing this is by use of multiple SOI layers, such as can be supplied by BCO Technologies plc, of Belfast BT17 0LT, Northern Ireland.

According to this embodiment, first the vertical waveguides and then coupling waveguides are formed by means of photolithography. The horizontal waveguides are next formed, and the coupling waveguide is then released from the substrate. At this stage the coupling waveguide is formed of two waveguides, one on top of the other, and that these waveguides are not coupled. Therefore when the coupler is in contact with the two waveguides, no light is transferred from one waveguide to the other. It is therefore necessary to couple the top waveguide with the lower waveguide on the coupling waveguide. This type of coupling is made possible by etching part of the top silicon waveguide and the oxide underneath, and then regrowing silicon such the bottom and top silicon waveguides become connected. This regrown silicon should preferably have a tapered structure in order to reduce any scattering effects.

In accordance with yet another preferred embodiment of the present invention, there is provided an optical switching device including, a planar substrate, at least a first and a second waveguide associated with the substrate, and a coupling medium, which, when activated, creates an optical path parallel to the plane of the substrate, such that at least part of light propagating along the first waveguide is coupled into the second waveguide. The first and the second waveguides may preferably cross each other, and the crossing may be on different planes. Each of the different planes may preferably include one of the waveguides and an associated insulating layer, the insulating layer being operative to separate the waveguides. Preferably, the different planes may be formed by means of insulating layers of different heights beneath the first and the second waveguides.

In the above-mentioned optical switching device, the ends of the coupling medium may be preferably shaped such that light is transferred by mode coupling from the end contacting the first waveguide to the end contacting the second waveguide.

In accordance with yet another preferred embodiment of the present invention, the coupling medium creates an optical path between the waveguides at different planes. The waveguides are preferably formed by patterning and etching technologies, and may be made of silicon, gallium arsenide, gallium nitride, a III-V compound, lithium niobate, silica, or a polymer. The insulating layer may preferably be silicon dioxide, silicon nitride, titanium dioxide or a polymer. Furthermore, the insulating layer preferably has an index of refraction smaller than that of the waveguide material.

There is further provided in accordance with still another preferred embodiment of the present invention, an optical switching device a sdescribed above, wherein the coupling medium is a suspended coupling waveguide, and the optical path is created by movement of the suspended waveguide towards the first and second waveguides, such that mode coupling occurs between the first waveguide and the coupling waveguide and between the coupling waveguide and the second waveguide. The movement of the suspended waveguide towards the first and second waveguides is preferably such that contact may be made between the coupling waveguide and the first and second waveguides. In accordance with a further preferred embodiment of the present invention, the switch also includes an actuator operative to move the coupling waveguide.

There is even further provided in accordance with another preferred embodiment of the present invention, a optical switching device as described hereinabove and wherein optical amplifiers are integrated in the waveguides. Furthermore, in accordance with yet another preferred embodiment of the present invention the optical path may be modulated by creating a wavelength sensitive coupling grating on the coupling suspended waveguide such that the modulation affects the intensity of the coupled light. In accordance with a further preferred embodiment of the present invention, in the optical switching device described above, at least one of the first and second waveguides are also suspended, and the optical path is controlled by the bending of at least one of the first and second waveguides and the coupling suspended waveguide. Alternatively and preferably, the geometry of the waveguide in the region of the coupling is predetermined to enhance the coupling. The suspended coupling waveguide, according to yet another preferred embodiment, may have a higher index of refraction than the first and second waveguides.

There is also provided in accordance with a further preferred embodiment of the present invention, an optical switching as described above, wherein the first and the second waveguides are shaped such that a central rib is formed on the waveguides in the region where the waveguides cross each other. The rib may preferably be diverted to a side of the waveguides in the region where the coupling medium is in contact with the waveguides.

In accordance with yet another preferred embodiment of the present invention, there is provided an optical switching network including a first set of waveguides, a second set of waveguides crossing the first set at an angle, wherein each of set sets of waveguides includes at least two waveguides, and at least one coupling medium placed close to the crossing point of one waveguide of the first set of waveguides and one waveguide of the second set of waveguides, such that when the coupling medium is activated, it creates an optical path such that at least part of the light propagating along the one waveguide of the first set of waveguides is coupled into the one waveguide of the second set of waveguides. The waveguides of the first set of waveguides and the waveguides of the set of waveguides preferably cross each other on different planes. Each of the different planes preferably includes the waveguides of one of the sets of waveguides and an insulating layer, the insulating layer being operative to separate the waveguides where they cross. Preferably, the different planes are formed by means of insulating layers of different heights located beneath the waveguides of the first and the second sets of waveguides at their crossing point. In accordance with yet another preferred embodiment, the waveguides are formed by patterning and etching technologies. Optical amplifiers may preferably be integrated in the waveguides.

There is further provided in accordance with yet another preferred embodiment of the present invention, an optical switching network as described above, wherein the at least one coupling medium is a suspended coupling waveguide, and the optical path is created by movement of the suspended waveguide towards the one waveguide of the first set of waveguides and the one waveguide of the second set of waveguides, such that mode coupling occurs between the one waveguide of the first set of waveguides and the coupling waveguide, and between the coupling waveguide and the one waveguide of the second set of waveguides. In this optical switching network, the movement of the suspended waveguide towards the one waveguide of the first set of waveguides and the one waveguide of the second set of waveguides is such that contact is preferably made between the coupling waveguide and the one waveguide of the first set of waveguides and the one waveguide of the second set of waveguides.

In accordance with still another preferred embodiment of the present invention, there is provided an optical add and drop module, including an input port, an output port, a port for adding information signals to the output port, a port for dropping information signals from the input port, wherein the adding and dropping of information signals is performed by an optical switching device of the type described hereinabove.

There is further provided in accordance with still another preferred embodiment of the present invention, an optical add and drop multiplexer, including a plurality of channels each channel adapted to convey light of a different wavelength, at least one of the channels including an optical add and drop module as described above.

In accordance with a further preferred embodiment of the present invention, there is also provided a method of enhancing roughness quality of a reactive ion etched side wall, including the steps of oxidizing the side wall to create an oxidized layer, and selective etching of the oxidized layer.

There is provided in accordance with yet a further preferred embodiment of the present invention, a method of enhancing roughness quality of a reactive ion etched side wall, including the step of performing a subsequent wet etching process.

Furthermore, in accordance with yet another preferred embodiment of the present invention, there is provided a method of enhancing roughness quality of the surface of contacting side walls, including the step of repeatedly closing the contacting side walls at a high repetition rate such that the surface becomes smoothed by the repeated closing.

### BRIEF DESCRIPTION OF THE DRAWINGS

The present invention will be understood and appreciated more fully from the following detailed description, taken in conjunction with the drawings in which:

FIG. 1A is a schematic view of two adjacent waveguides, effectively widely spaced from each other, showing no optical coupling between them, and FIG. 1B shows the same two waveguides in close proximity or in contact, showing optical coupling between them, to illustrate the principle of coupled mode theory;

FIG. 2 shows the result of a computer simulation showing light coupled between two 2 μm wide waveguides having an index of refraction of 3.5, and surrounded by a vacuum;

FIG. 3 is a close-up view of the simulation result of FIG. 2, showing the first 80 μm of the coupled waveguides, and indicating that most of the light is coupled from one waveguide to the other within 40 μm;

FIG. 4 is the same as FIG. 2 but with a separation of 0.04 μm between the two waveguides, as a result of which, the coupling length becomes approximately 250 μm;

FIG. 5 is the same as FIG. 2 but with a separation of 0.1 μm between the two waveguides resulting in a coupling length of about 800 μm;

FIG. 6 is the same as FIG. 2 but for 5 μm wide waveguides in contact, resulting in a coupling length of approximately 250 μm;

FIGS. 7A and 7B, which are schematic drawings of prior art MEMS, illustrating respectively the differences between in-plane Degrees Of Freedom (DOF), and out-of-plane DOF;

FIG. 8 is a schematic view of a preferred arrangement for the layers of material in which can be constructed an optical switching device or network, according to preferred embodiments of the present invention;

FIGS. 9A and 9B schematically show details of a single optical switch according to a preferred embodiment of the present invention, respectively in the open and closed positions;

FIG. 10A shows a 4×4 switching network comprised of an array of single switches of the type shown in FIG. 9; FIGS. 10B and 10C show preferred embodiments of the waveguide cross section used in the embodiment of FIG. 10A;

FIGS. 11A and 11B show examples of the basic coupler geometry based on mode coupling;

FIGS. 12A and 12B show the couplers of FIGS. 11A and 11B, constructed using a grating structure between the two waveguide elements of the coupler;

FIGS. 13A and 13B are schematic illustrations of the input to the coupler of the switch shown in FIG. 9B, with an adiabatic transition;

FIGS. 14A and 14B are schematic illustrations of another preferred embodiment of a switch, in which the coupling efficiency is increased by bending the input waveguide;

FIGS. 15A and 15B are representations of a computer simulation of the coupling of a bent-waveguide coupler of the type shown in FIGS. 14A and 14B;

FIGS. 16A to 16C are schematic illustrations of computer simulations of another preferred embodiment, in which the coupling is accomplished by means of a tapered coupler waveguide with a larger index of refraction than the main waveguide;

FIG. 17 is a schematic illustration of a computer simulation showing light scattering from a waveguide crossover;

FIGS. 18A to 18D are schematic illustrations of a method of construction of optical crossovers, according to another preferred embodiment of the present invention, intended to solve the problem of cross-over leakage shown in FIG. 17;

FIGS. 19A and 19B are schematic illustrations to further clarify the configuration of the cross-over according to the preferred embodiment shown in FIG. 18D;

FIGS. 20A to 20D illustrate the fabrication steps performed in order to produce a connection between the top layer and the bottom layer in the coupling waveguide shown in FIG. 18D;

FIG. 21 is a computer simulation showing light propagating from the upper waveguide to the lower waveguide, in a coupler such as that of FIG. 18D;

FIG. 22 illustrates a method of packaging an integrated optics chip, and integrating it with its input and output optical fibers, using wafer level packaging or flip chip technology;

FIGS. 23A to 23D are schematic drawings of an alternative method of constructing the switching network of FIG. 10A, according to another preferred embodiment of the present invention, using ribbed waveguide;

FIGS. 24A to 24D are schematic drawings of an alternative method of constructing a switching network, according to another preferred embodiment of the present invention, using a ribbed waveguide with a wandering rib;

FIG. 25 is a schematic diagram of another preferred method of optical switch construction, to reduce losses at all of the optical waveguide crossovers in the network;

FIGS. 26A to 26C are schematic drawings of a variably controlled coupling clement, based on a variation of the single switch embodiment shown in FIGS. 9A and 9B;

FIG. 27 is a representation of a complete automated optical attenuator system, based on the variable coupling element described in FIGS. 26A to 26C;

FIG. 28 illustrates schematically an optical gain equalizing system, constructed and operative according to another preferred embodiment of the present invention, using the control elements shown in FIGS. 26A to 26C;

FIG. 29 illustrates schematically an optical gain equalizing system such as that of FIG. 28, but wherein the level sensor is remotely installed;

FIG. 30 illustrates schematically an optical Wavelength Add and Drop (WAD) system, constructed and operative according to another preferred embodiment of the present invention, using optical switches according to the present invention;

FIG. 31 shows an Add and Drop module of FIG. 30, constructed using optical switches based on those shown in FIGS. 9A and 9B; and

FIG. 32 shows part of a complete multichannel WAD system, constructed and operative according to another preferred embodiment of the present invention, utilizing Add and Drop modules shown in FIG. 31.

### DETAILED DESCRIPTION OF PREFERRED EMBODIMENTS

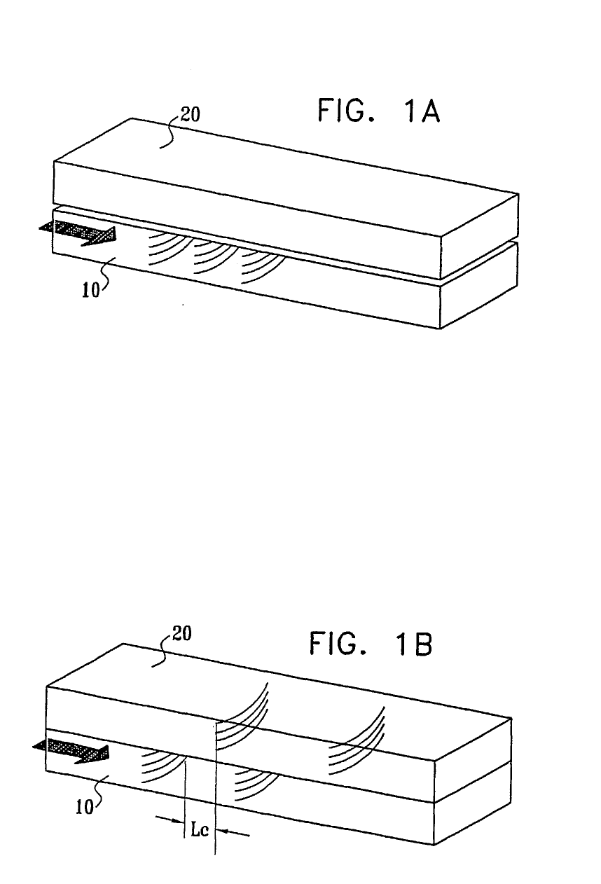

Reference is now made to FIGS. 1A and 1B, which schematically show a pair of adjacent waveguides illustrating the theory of coupled modes between two such waveguides. FIG. 1A is a schematic view of the two waveguides 10, 20, effectively widely spaced from each other, showing no optical coupling of the light in the input waveguide 10, to the second waveguide 20. FIG. 1B shows the same two waveguides in close proximity or in contact, showing optical coupling between them. According to coupled mode theory, the light intensity in the two waveguides are related in the following way:

$$Ib ( z ) - Ia ( 0 ) \frac{{k}^{2}}{{k}^{2} + {δ}^{2}} {sin}^{2} ( \sqrt{{k}^{2} + {δ}^{2}} z ) \qquad ( 1 )$$

where:

Ia (0) is the light intensity at the input to waveguide 10,

Ib(z) is the light intensity in waveguide 20 after a distance z from the initial contact point,

k is the coupling coefficient and

2δ is the difference between the propagation constants of the two modes.

The coupling length Lc, is defined as the length by which all the light intensity from the input waveguide has transferred to the second waveguide. From Equation 1, the coupling length can be calculated as:

$$Lc = \frac{π}{2 \sqrt{{k}^{2} + {δ}^{2}}} \qquad ( 2 )$$

Reference is now made to FIGS. 2 to 6, which show the results of computer simulations showing light coupled between two waveguides having an index of refraction of 3.5, and surrounded by a vacuum of unity refractive index. All of the simulations shown in this application were performed using a commercial simulator program called Beam PROP, Version 4.0, supplied by Rsoft, Inc., of Ossining, N.Y. 10562. The intensity of the shading in the simulations is representative of the light intensity.

FIG. 2 shows a simulation of the light intensity in two 2 μm wide waveguides in contact with each other. The ordinate is the distance z from the initial contact point between the waveguides. Light is launched from the lower end of waveguide 30, and the simulation shows that after about 40 μm most of the light is transferred to the second waveguide 40. The coupling length is thus approximately 40 μm. This energy is seen to be transferred back into waveguide 30 after another 40 μm, and so on as the distance z increases.

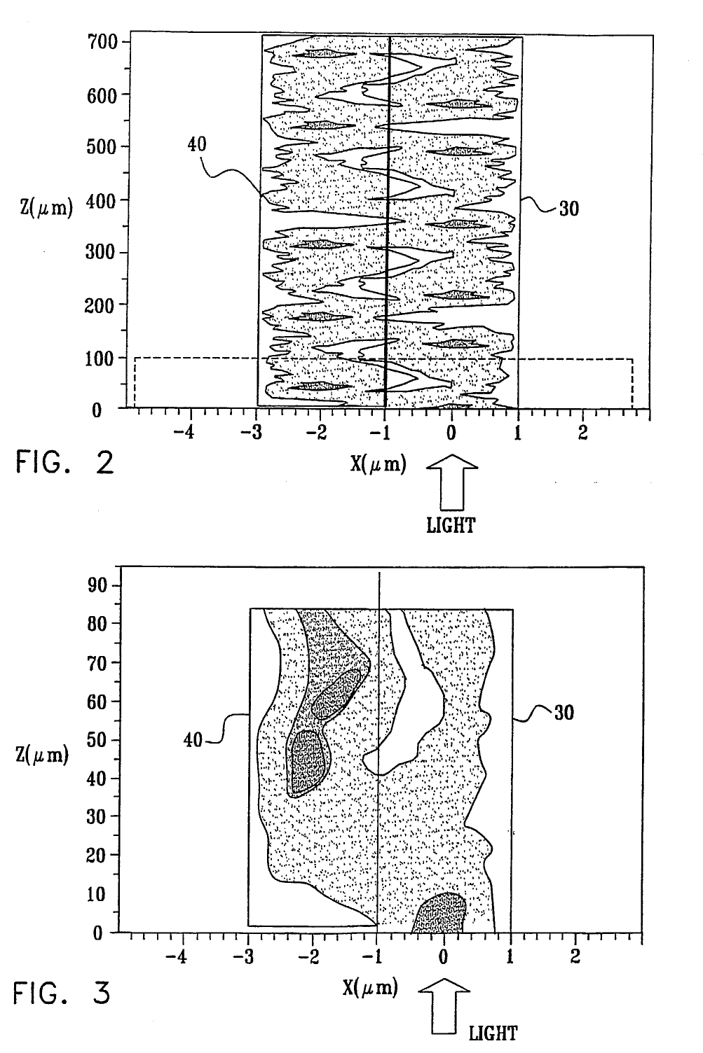

FIG. 3 is a close-up view of the simulation result of FIG. 2, showing the first 80 μm of contact.

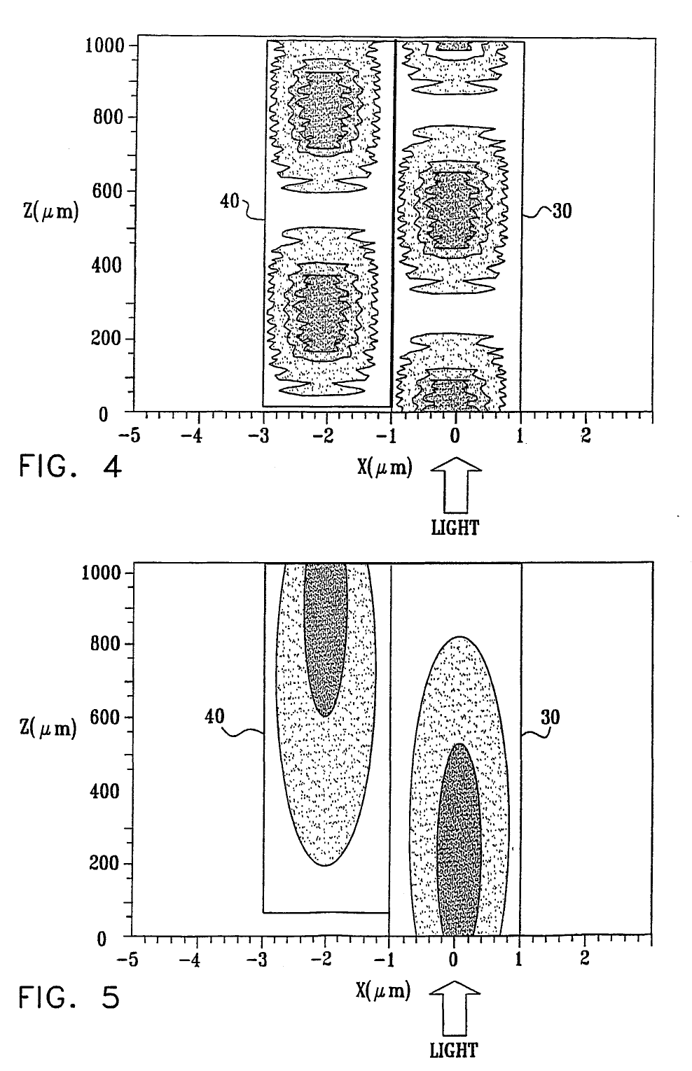

Reference is now made to FIG. 4, which shows a simulation of the two waveguides of FIG. 2, but separated by a gap of 0.04 μm. The coupling length is seen to have grown to approximately 250 μm.

FIG. 5 shows a simulation of the two waveguides of FIG. 2, but separated by a gap of 0.1 μm, and the coupling length is now seen to be 800 μm.

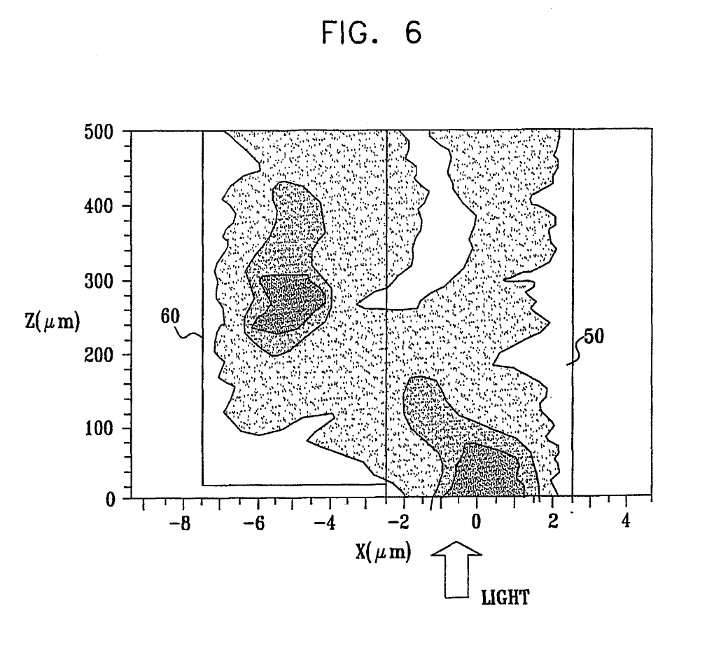

FIG. 6 shows a simulation similar to that shown in FIG. 2, but with waveguides 50 60, of width 5 μm. The coupling length is approximately 250 μm.

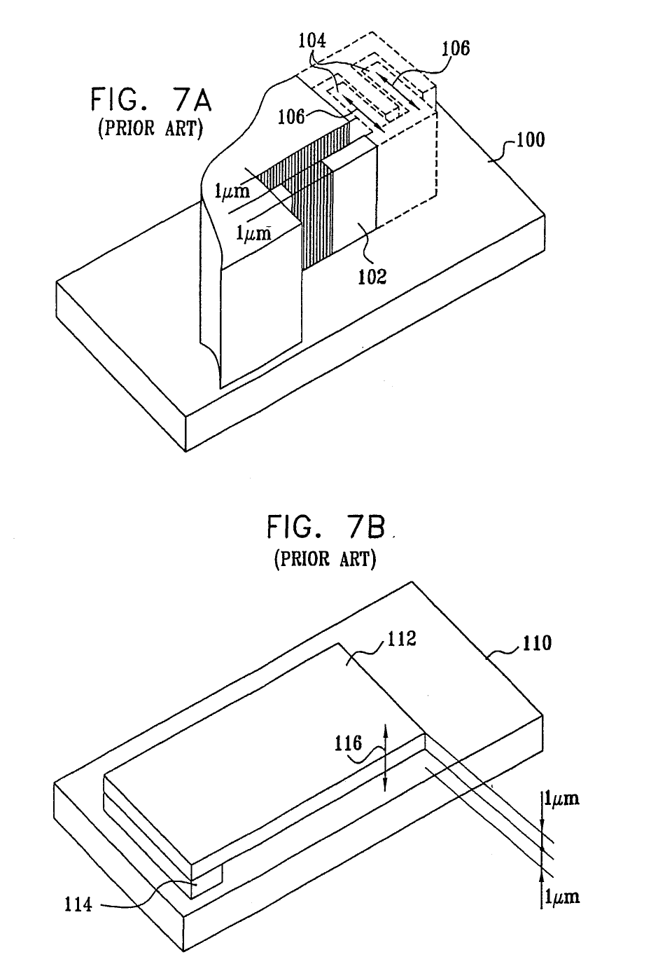

Reference is now made to FIGS. 7A and 7D, which are schematic drawings of examples of MEMS from the prior art, including sensors and actuators, to illustrate the differences between those having an in-plane Degree Of Freedom (DOF), and those having an out-of-plane DOF.

FIG. 7A shows a drawing of the device described in the by D. Haronian, the inventor of the present application, entitled “Direct Integration (DI) of solid state stress Sensors with Single Crystal Micro-electro-mechanical systems for integrated displacement sensing,” published in the proceedings of the Twelfth IEEE International Micro Electro Mechanical Systems Conference, Jan. 17-21, 1999, pp. 88-93, Orlando, Fla., which has an in plane DOF. FIG. 7A shows a conductive wafer 100, onto which is constructed an MEMS including a cantilevered actuator 102, which is operative to move two tongues 104, into and out of gaps in the bridge structure. The motion limit is approximately 1 μm. The direction of motion, as depicted by the arrows 106, is in the plane of the substrate 100, and the device is therefore described as having an in-plane Degree Of Freedom (DOF).

FIG. 7B shows a drawing of the device described in the above mentioned article by D. Haronian, which has an out-of-plane DOF. The MEMS device is constructed onto a conductive wafer 110, and consists of a cantilever 112, mounted on a support structure 114. The end of the cantilever 12 is capable of motion of approximately 1 μm, but in this case, the motion is perpendicular to the plane of the wafer 110. The device is therefore described as having an out-of-plane DOF.

The present invention is an optomechanical device based on mode coupling as described by the couple mode theory, as illustrated in FIGS. 2A to 6. Although this device is described and claimed in this application as a “switch”, or a “switching device”, it will be understood by one skilled in the art that, like the aforementioned prior art device described in U.S. Pat. No. 5,612,815 to Labeye et al., a suitably configured device of the present invention could equally well be used as a sensor, and the invention is not therefore to be understood to be limited to switches.

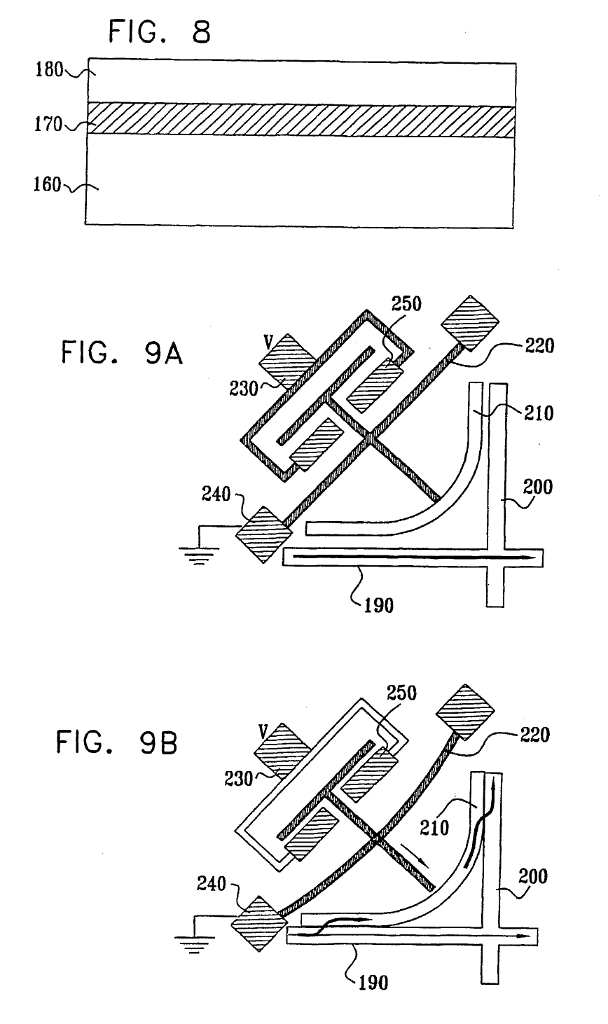

Reference is now made to FIG. 8, which is a schematic view of a preferred arrangement for the layers of material in which can be constructed an optical switching device or network, according to preferred embodiments of the present invention. In FIG. 8, the waveguide layer 180 has index of refraction that is higher than the surrounding medium. The sides and top are generally air, but can be another material so long as it has a smaller index of refraction. The buffer layer 170 has a smaller index of refraction, in order to prevent light from leaking into the substrate. In the illustrated embodiment, the waveguide layer 180 is silicon, having an index of refraction n=3.5, and the buffer layer 170 is Silicon Dioxide (SiO2) with an index of refraction of 1.5. Such Silicon on Insulator wafers (SoI) are commercially widely available, as mentioned hereinabove.

The waveguide can also be made of gallium arsenide, gallium nitride, other Ill-V compounds, lithium niobate, silica, or even a polymer. The insulating layer can also be silicon nitride, titanium dioxide or a polymer

Reference is now made to FIGS. 9A and 9B, which schematically show details of a single optical switch, constructed and operative according to a preferred embodiment of the present invention. FIG. 9A shows the switch in the open position, and FIG. 9B in the closed position. In these figures, 190 is a horizontal input waveguide, while 200 is a vertical output waveguide crossing it. A section of curved waveguide 210 acts as a coupler, whose two ends couple respectively to the horizontal and vertical waveguides. In FIG. 9A, the coupler 210 is shown distanced from the waveguides, typically by a distance of 1 μm, such that no light can be coupled into it from the horizontal waveguide 190, or, if there were any light propagating in the coupler, out of it to the vertical waveguide 200. In order to move the coupler towards the waveguides, an electrostatic actuator is preferably used. The coupler is connected to a flexible suspended beam 220, fixed on both its ends. Opposite the suspending beam is an electrode 250. Both the electrode 250 and the suspending beam 220 are metal coated or are made of highly doped silicon, such that when a voltage is applied between the pads 239, 240, electrostatic force is generated which pushes the coupler against both waveguides, as shown in FIG. 9B. In this position, light propagating along the horizontal waveguide 190 is coupled into the coupler 210, and from the coupler into the vertical waveguide 200. In order that the coupling process be efficient at both ends of the coupler section, the lengths of the straight sections of the coupler which make contact with the waveguides should be approximately equal to the coupling length for the waveguide dimensions used. Longer straight sections are simply superfluous.

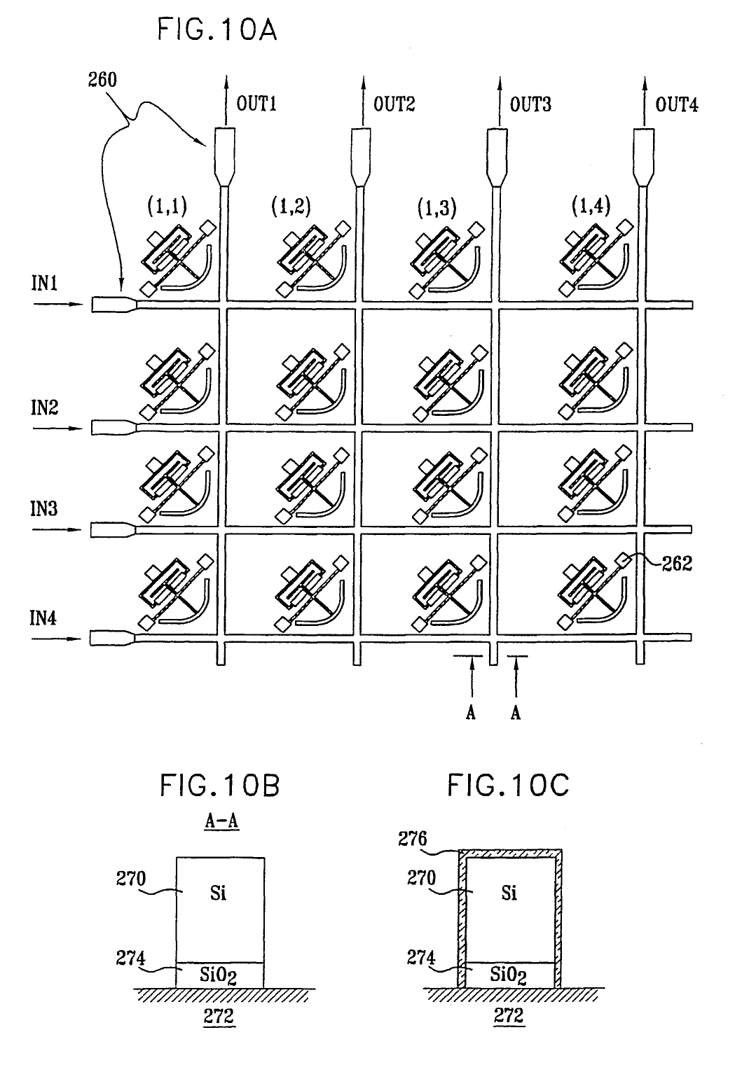

Reference is now made to FIG. 10A, which is a schematic illustration of another preferred embodiment of the present invention, showing, as an example, a 4×4 switching network comprised of an array of single switches of the type shown in FIG. 9. The network is constructed within layers of the type described in FIG. 8 with the light propagating along the top layer. In FIG. 10A, the input and output ports 260 are marked IN1, IN2 . . . etc., representing light signals arriving from an array of input fibers, and OUT1, OUT2, . . . etc., representing light signals connected to an array of output fibers. The function of such a network is to enable the connection of any input fiber to any output fiber. For example, in order to connect IN1 to OUT3, the switch marked (1,3) is closed by bending the coupler of switch (1,3) so that it connects its associated horizontal and vertical waveguides.

Reference is now made to FIGS. 10B and 10C, which illustrate two preferred embodiments of waveguides for use in the embodiments of this application. FIG. 10B shows the cross section at A-A of a normal silicon waveguide 270, isolated from the silicon substrate 272 by a layer of silicon dioxide 274. FIG. 10C shows another preferred embodiment, wherein the waveguide of FIG. 10B is clad in a layer 276 having a refractive index less than that of the silicon. According to one preferred embodiment, the layer is titanium dioxide, having n=2.3. This layer 276 is operative in reducing the number of higher order modes propagating in the waveguide, and in reducing any polarization dependence of the coupler.

The switch array shown in FIG. 10A, has a number of advantages over prior art switch arrays:

1. There is very small cross talk between the vertical waveguides and the horizontal waveguides. The cross talk present arises because of leakage at each cross. This cross talk is found to be very small, of the order of −65 db.

2. The array has low insertion losses, since the waveguides are straight, with no bending. As will be discussed hereinbelow, these insertion losses may not, in fact, be low enough for all applications, and additional modifications according to further preferred embodiments of the present invention, may be required, as will be explained below.

3. It is possible to utilize a DI sensor unit, as described in U.S. Pat. No. 6,128,961 for “Micro-electro-mechanics systems (MEMS)” to the present inventor, in order to provide feedback information to the array control on the switch state. Such a sensor is shown marked 262 in FIG. 10A.

Reference is now made to FIGS. 11A to 16C, which show various preferred embodiments of the coupler construction and operation for use in the optical switches of the present invention. In FIGS. 11A and 11B are shown preferred examples of the basic coupler geometry. These figures show the horizontal input waveguide and the coupler waveguide lying on top of it, both of these waveguide elements being 5 μm wide. As previously explained in FIGS. 2A to 6, the light from the horizontal waveguide is coupled into the coupler through the evanescent field surrounding the waveguides. In FIGS. 11A and 11B, the coupling length is estimated to be around 200 μm. If 2 μm wide waveguides were to be used, as shown in FIGS. 2 and 3, the coupling length would be reduced to around 40 μm if the surfaces were smooth. In practice, because of the surface roughness resulting from the etching process, typically 20 nm or worse, the coupling length is approximately 140 μm.

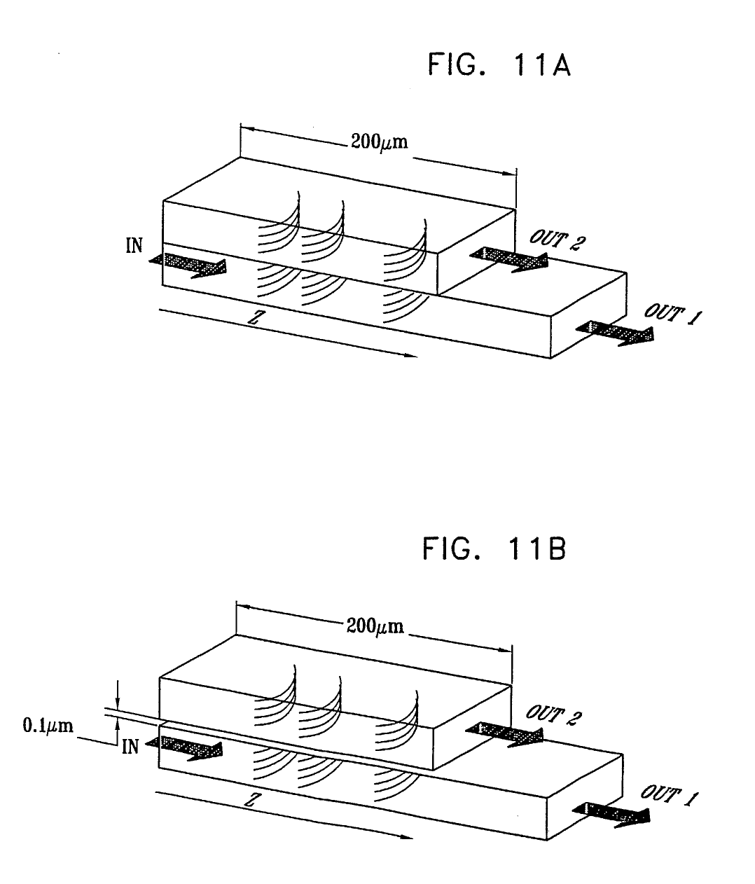

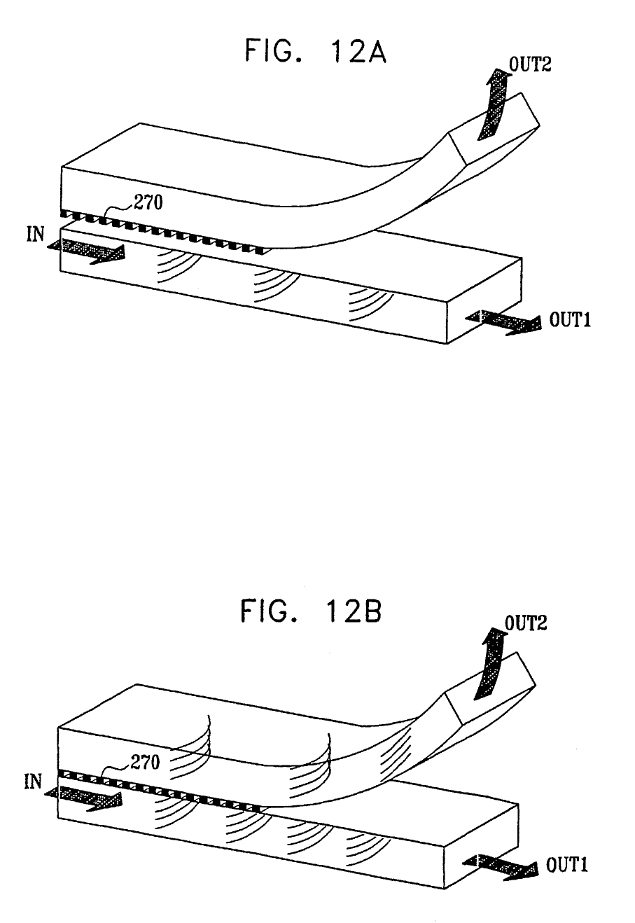

Reference is now made to FIGS. 12A and 12B, which show further preferred embodiments of the present invention, whereby the coupler is constructed using a grating structure 270 between the two waveguide elements of the coupler. Such a grating coupler structure has been described by N. Izhaky et al., in an article entitled “Characteristics of grating-assisted couplers”, published in Applied Optics, Vol. 38, No. 34, pp. 6987-6993, 1999. Such a structure enhances the coupling and thus reduces the length required to couple the light. The grating is preferably constructed on the side of the coupler waveguide facing the horizontal waveguide. In the situation shown in FIG. 12A, the switch is open, and the coupled signal OUT2 is negligible compared with OUT1. When the coupler is moved into contact with the horizontal waveguide, optical power is transferred to OUT2.

Reference is now made to FIGS. 13A and 13B, which are schematic illustrations of the input to the coupler, according to another preferred embodiment of the present invention, in which the horizontal waveguide is shaped such that it goes from a wide waveguide to a narrow waveguide through an adiabatic transition 280. Such a transition reduces mode mixing and losses at the transition. When the coupler is unconnected, as in FIG. 13A, negligible signal flows from the input, marked IN, to the coupler, OUT2. When the coupler is closed, as in FIG. 13B, the geometrically completed adiabatic transition ensures that part of the light from input IN is coupled to OUT2.

Reference is now made to FIGS. 14A and 14B, which are schematic illustrations of another preferred embodiment, in which the coupling efficiency is increased by bending the horizontal waveguide from its previously described straight configuration, such that the optical signal is geometrically directed into the coupler. This is accomplished by suspending both the input waveguide and the coupling waveguide, such that when the coupling waveguide is moved into contact with the straight input waveguide, it deforms the straight waveguide into a bent shape. FIG. 14A shows a representation of this embodiment in the open position, with the input waveguide straight. FIG. 14B shows the coupler in the closed position, with the straight input waveguide bent, such that part of the input signal is coupled into OUT2.

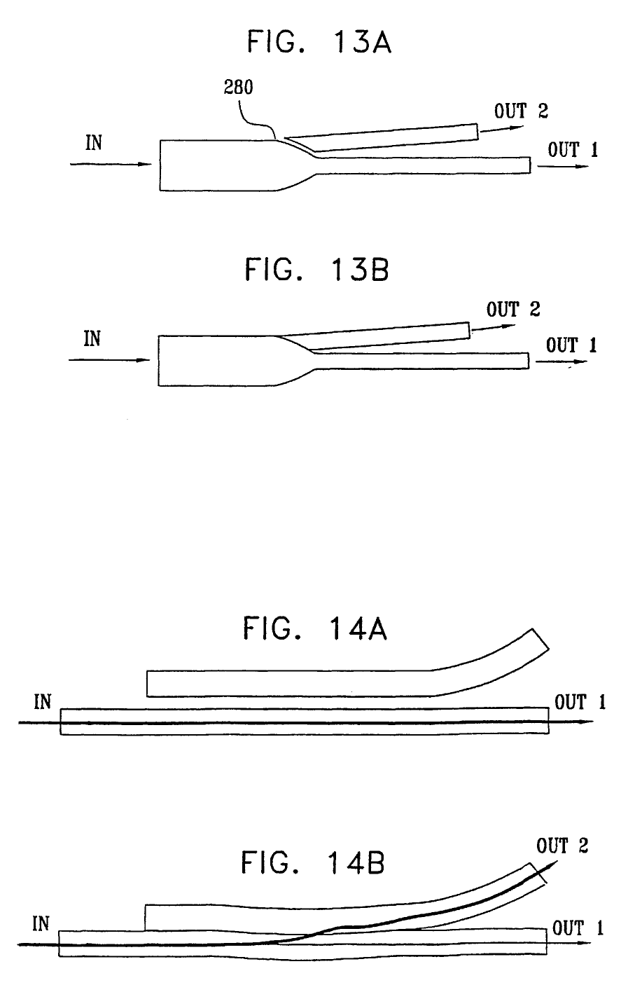

FIGS. 15A and 15B are representations of a computer simulation of the coupling of such a bent-waveguide coupler. FIG. 15A is a schematic drawing of the structure that was simulated, showing the bent waveguide 280, and the coupling waveguide 290. The length of the two waveguides in these figures is approximately 50 μm, and each waveguide is preferably 2 μm in width. FIG. 15B is a schematic representation of the simulation results, where the input signal IN to the bent waveguide is transferred into the coupled waveguide, as indicated by the peak of intensity 300 at the output OUT2 of the coupled waveguide.

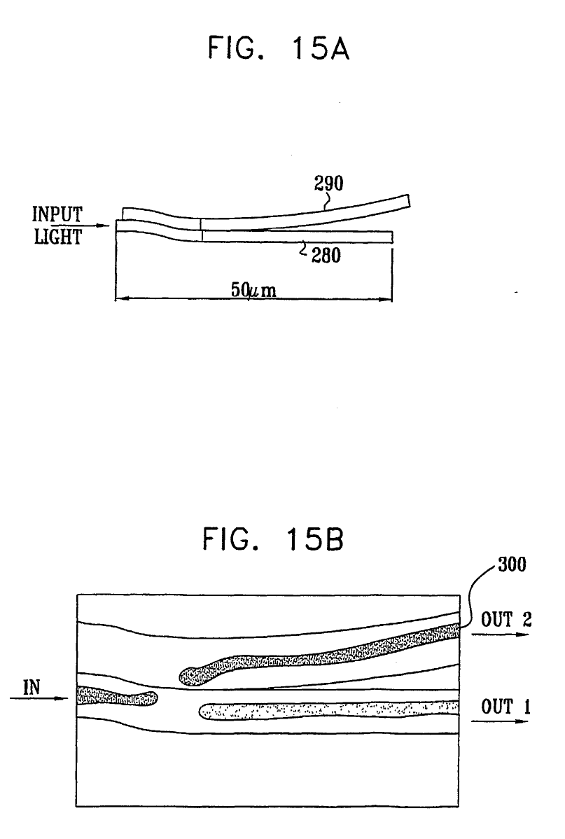

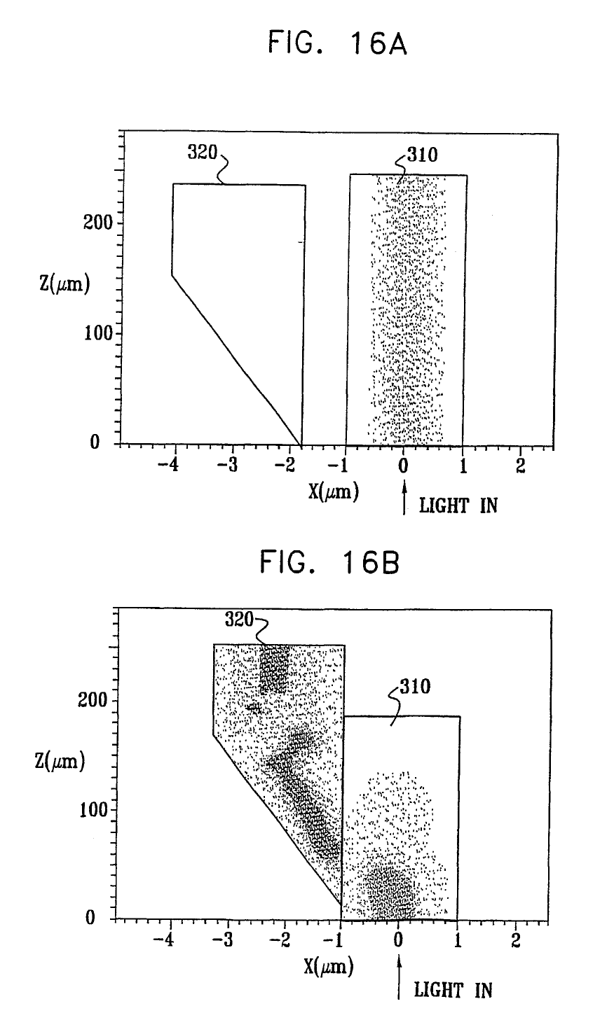

Reference is now made to FIGS. 16A to 16C, which are schematic illustrations of computer simulations of another preferred embodiment of the present invention, in which the coupling of the light out of the main waveguide is accomplished by means of a tapered coupler waveguide with a larger index of refraction than the main waveguide. In FIGS. 16A and 16B, the main waveguide 310 preferably has an index of refraction of 3.5 and the tapered coupler waveguide 320 has an index of refraction of 3.6. In FIG. 16A, the main waveguide 310 is shown separated from the coupler waveguide 320 by 1 μm, and the light propagating along the main waveguide is not disturbed or coupled out. In FIG. 16B, the tapered coupler 320 is brought into contact with the main waveguide 310 and most of the energy is shown to be coupled into the tapered coupled waveguide 320. For comparison purposes, FIG. 16C shows the same configuration, but with the coupler 330 having an index of refraction of 3.5, as in the coupler embodiments described previously to the embodiments of FIGS. 16A to 16C. When comparing the results in FIGS. 16B and 16C, it is apparent that the use of a coupler waveguide with a refractive index only 0.1 higher, results in a significantly larger energy coupling factor. It is possible to implement such a small change in the index of refraction of silicon, by means of the well-known techniques of ion implantation or diffusion of impurities.

Reference is now made to FIG. 17, which is a schematic illustration of a computer simulation showing light propagating in a horizontal waveguide that is crossed by a vertical waveguide. This simulation shows that part of the light from the horizontal waveguide actually leaks into and propagates inside the vertical waveguide 360. This leakage is found to be very small (less than −65 db), so from the point of view of cross talk, such a leakage level is negligible for all practical purposes. However, the computer simulation also shows that the cross itself scatters part of the light, as shown by the weak fields marked 370, 371 and 372 in FIG. 17. This scattering loss is estimated to be in the range of 0.1 db to 0.2 db per crossover. Therefore, for networks of the order of 32×32, the light in the longest path goes though 64 crosses and therefore the scattering losses can total up to approximately 64×0.1 db=6.4 db. When this is added to the inherent losses in the switch itself, which total about 2 db, and the insertion loss of the fiber-to-waveguide transition and vice versa, each amounting to about 1 db, the total loss in the longest path is of the order of 10 db. Though this magnitude of loss is still acceptable for many applications, scaling up the matrix size to 1024×1024, which is a much more practically utilizable size, would result in unacceptably high losses.

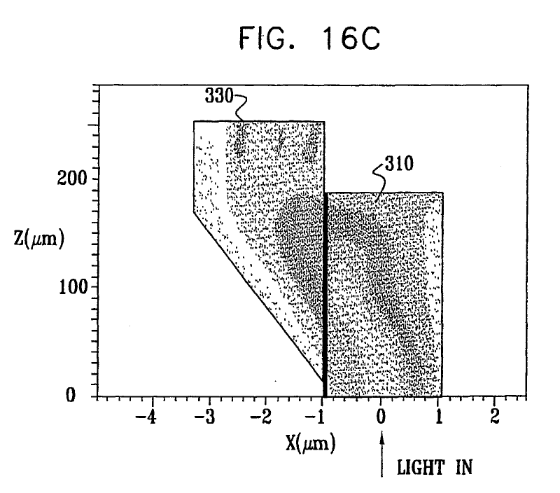

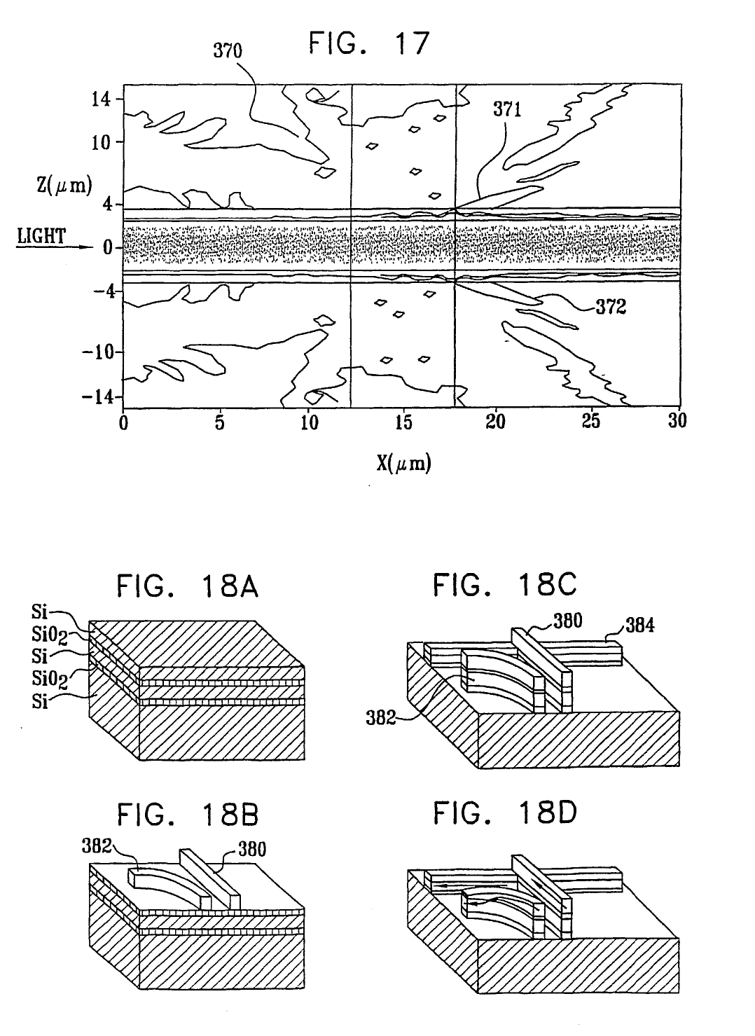

Reference is now made to FIGS. 18A to 18D, which are schematic illustrations of a method of construction of the optical crossovers, according to problem of cross-over leakage. According to this method, the crossing waveguides are constructed to be located in different layers. Thus, instead of a single Silicon-on-Insulator layer, two sets of such layers are used. FIGS. 18A to 18D show the fabrication process of a single switching element. FIG. 18A shows the starting wafer composition, comprising a silicon substrate, with successive layers of silicon dioxide, silicon, silicon dioxide and silicon grown on top of it. FIG. 18B shows the result of etching away the top silicon layer to leave two shaped layers which will become the horizontal waveguide 380 and the coupling waveguide 382 in the completed cross-over. In FIG. 18C, successive SiO₂, Si and SiO₂ layers are etched away to the silicon substrate, leaving the horizontal 380, the coupling 382, and the vertical 384 waveguides. The top silicon layer of the vertical waveguide 384 has also been etched away in FIG. 18C, such that there is no contact between the horizontal waveguide and the vertical waveguide, and the two waveguides are fabricated one on top of the other. Finally, in FIG. 18D, the coupling waveguide is treated by a process to be described below. In the structure of the embodiment of FIG. 18D, there are no scattering losses in the crossing waveguides, since they do not actually cross each other, and the leakage cross talk also is much better than −65 db.

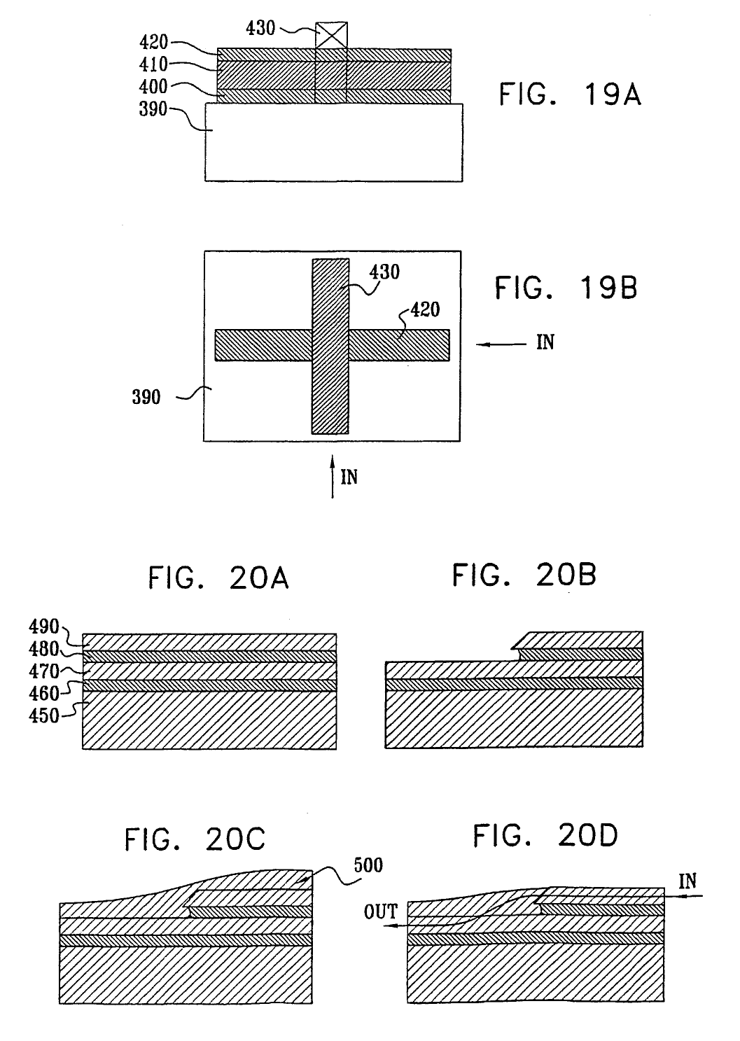

Reference is now made to FIGS. 19A and 19B, which are schematic illustrations to further clarify the configuration of the cross-over according to the preferred embodiment shown in FIG. 18D. FIG. 19A is a cross-sectional view of the layers comprising the cross-over configuration of FIG. 18D, and FIG. 19B shows a plan view of this cross-over. FIG. 19A is a cross-sectional view at the cross-over looking along the direction of the horizontal waveguide 430. The layers beneath are the Si substrate 390, a layer of SiO₂ 490, a layer of Si 410 in which the vertical waveguide is fabricated, and a layer of SiO₂ 420, for optically isolating the two waveguides at the cross-over. The plan view in FIG. 19B shows the Si substrate 390, the isolating layer of SiO₂ 420 on top of the vertical waveguide, and the Si horizontal waveguide 430.

However, as the vertical and horizontal waveguides are on different planes a problem is created in the coupler, as when it is in contact position with the two waveguides it does not connect the vertical waveguide with the horizontal waveguide because of their different heights. Therefore, as show in FIG. 18D, the two separate upper and lower waveguides on the coupler waveguide 382, are joined such that light from the upper waveguide in the coupler is transferred to the lower waveguide.

One preferred method of forming such a connection in the coupling waveguide is shown in FIGS. 20A to 20D, which show the fabrication steps performed in order to produce a connection between the top layer and the bottom layer in the coupling waveguide 382 of FIG. 18D. Referring now to FIG. 20A, on top of the silicon substrate 450 are formed sequential layers of silicon dioxide 460, silicon 470, silicon dioxide 480 and silicon 490. Next, the top silicon layer 490 and the silicon dioxide underneath it 480 are etched by wet enchants. The top silicon may preferably be etched by KOH (potassium hydroxide and water) or by EDP (ethylenedianiine, pyrocatechol and water) solutions, as described by K. E. Bean, in the article “Anisotropy etching of silicon,” published in IEEE Transactions on Electron Devices, Vol. ED-25, pp. 1185-1193, (1978). Such an etching process is typically semi-isotropic and therefore a slope is formed in the side-wall of the silicon layer. This also applies to the silicon dioxide layer, 480, which can be etched using buffered HF. These etching steps result in the side-walls shown in FIG. 20B. The angle of the side-wall of the silicon layer is 53.7 degree when etched by KOH. In the next step, a layer of silicon 500 is grown, as shown in FIG. 20C. This layer may be grown by Chemical Vapor Deposition (CVD) or by means of sputtering. This growing step can either be a blanket process, in which the growth takes place over the whole wafer, or it can be a selective process, only on the exposed silicon layer. FIG. 20C shows the different layers after this deposition step. In the next step, the wafer is polished using conventional Chemical Mechanical Polishing (CMP), such that the top silicon layer is removed. This step is shown in FIG. 20D, and the result is a layer of silicon connecting the top waveguide with the bottom waveguide in that region where the top waveguide has been removed.

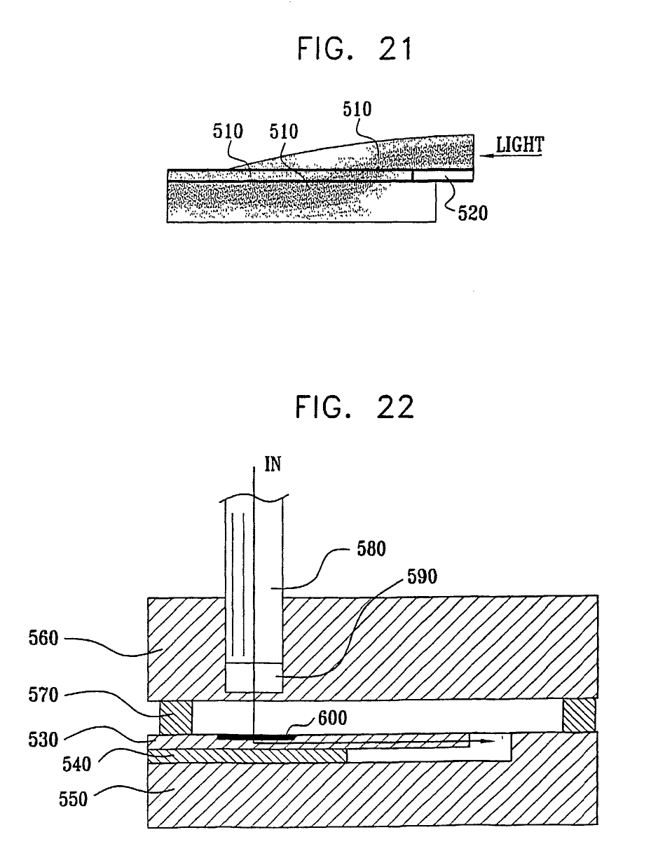

Reference is now made to FIG. 21, which is a schematic illustration of a computer simulation showing light propagating from the upper waveguide to the lower waveguide, in a coupler, such as that of FIG. 18D, formed by the process shown in FIGS. 20A to 20D. In FIG. 21, layers 510 are silicon and layer 520 is silicon dioxide. In this simulation, the length of the bottom layer of silicon, which can be used to define the length of the coupling waveguide, was taken to be 120 μm, and the height of this layer was 2 μm. This results of the simulation show that most of the light propagates correctly from the top silicon layer into the bottom silicon layer.

Another method of solving the problem of the losses along the waveguides in the network is by the use of integrating optical amplifiers such as reported by W. Huang et al., in the article “Analysis of Folded Erbium-Doped Planar Waveguide Amplifiers by the Method of Lines”, published in Journal of Lightwave Technology, Vol. 17, No. 12, pp. 2658-2664, 1999. The basic method described is that of doping the waveguide with Erbium and pumping it with light in the 0.98 μm range. A photonic effect occurs whereby information propagating in the fiber at a wavelength of around 1.55 μm is amplified. It is thereby possible to integrate light amplification along the network. It is, for example, possible to dope all of the waveguides in the network with Erbium and to amplify the information propagating along the metrics using 0.98 μm pump light. The information from the input fibers can preferably be fed into the device by means of a coupling grating, or as will be shown hereinbelow in the embodiment described in FIG. 22, by using a standard butt coupling with an anti-reflection coating. Therefore for an n×m matrix there are ‘n’ fibers feeding the network. In a similar way it is possible to have amplifier fibers that couple 0.98 μm light to the matrices at regular intervals along the waveguides. These fibers can be integrated into the waveguide using the same mechanical support and grating coupling as the fibers carrying the information.

It should be noted that the term “waveguide” is used and claimed in this application to refer to any structure which is configured to convey optical signals of at least one range of wavelengths of light, whether in the ultraviolet, visible or infrared ranges. Waveguides so defined include, but are not limited to, optical fibers and integrated waveguides formed on chips, typically of silicon. The most preferred implementations of the present invention relate to integrated optics components, wherein the relative motion of the waveguides is achieved by producing suspended cantilever structures, including one or more suspended optical waveguide.

With regard to fabrication techniques, an enabling description of the processes for the production of a silicon nitride suspended optical waveguide structure may be found in the article by the inventor of the present application, D. Haronian, entitled “In-Plane Degree of Freedom Optical Waveguide Displacement Sensors based on Geometrical Modulation”, published in Sensors and Actuators, Vol. A 69, pp. 217-225 (1998), and in the article by K. A. Shaw, et al., entitled “SCREAM I: A Single Mask, Single-Crystal Silicon, Reactive Ion Etching Process for Microelectromechanical Structures”, published in Sensors and Actuators Vol. A 40, pp. 63-70 (1994), which are both are hereby incorporated by reference. The process described therein may be generalized to other types of waveguide by substituting etching steps appropriate to the materials used, as is known in the art. In each case, the structure may be regarded as a four-layer structure with a silicon beam providing mechanical support, a buffer layer (typically SiO₂), a waveguide layer and a masking layer which protects the lower layers during etching. Various electrode structures suitable for use in specific embodiments of the present invention may also be found in the aforementioned articles.

In addition to the SCREAM process described in the K. A. Shaw et al article, another enabling process based on Deep Reactive Ion Etching (DRIE) of SOI is described by H. Toshiyoshi et al., in the article “Micro-Electro-mechanical digital-to-analog converter (MEMDAC),” published in the proceedings of the 10^{th} International Solid-State Sensors and Actuators Conference, Sendai, Japan, Jun. 7-10, 1999, pp. 994-997. This method is similar to the general process know as surface micromachining, in which at least two layers are deposited on a substrate. One example of surface micromachining is described in the article by D. Haronian et al., entitled “Spring suspended corrugated membrane,” published in Journal of Micromechanics and Microengineering, Vol. 5, pp. 289-296, (1995). The method of Toshiyoshi et al differs from that of Haronian et al., in that instead of depositing the two layers as described by Haronian et al., the layers are formed in SOI wafers that are made by oxidation of one silicon wafer, bonding it to a counter silicon wafer and then thinning the counter silicon layer to the desired thickness. In this case the silicon dioxide serves as the sacrificial layer.

An alternative process for performing this fabrication process, is described in US Provisional Patent Application for “Integration of Actuators and WG using Spin-on Dopant (SOD)”, filed on Jul. 26, 2001, by the inventor of the present application. The process is based on combining doped and intrinsic silicon with deep RIE (DRIE), to achieve regions that are electrically conductive, and light guiding with low losses on the same chip.

As previously mentioned, this DRIE process does not produce side walls of sufficient smoothness for use in planar geometry optical switching applications. Typical roughnesses of the order of 20 nm are obtained. According to other preferred embodiments of the present invention, there are provided methods for increasing the surface smoothness. According, to a first preferred method, for a silicon waveguide, the surface is oxidized to produce a layer of silicon dioxide, which is smoother than the base silicon surface because of the non isotropic action of the oxidation process, which preferentially reduces bumps on the surface. The smoothed oxide layer is subsequently removed by means of selective wet etching, such as with buffered HF. The resulting clean silicon surface shows a roughness reduced to the order of several mn, compared with the approximately 20 nm resulting from the DRIE process.

According to a second preferred method, for a silicon waveguide, the surface is wet etched using a KOH or an EDP solution, as explained hereinabove. These solutions etch the silicon anisotropically, thereby smoothing the surface.

According to a third preferred method, the roughness quality of the surface of contacting side walls is improved by a bum-in process in which the side wall contacts are repeatedly closed at a high repetition rate such that the surface becomes smoothed by the impacting action of the repeated closing.

There is further provided, in accordance with another preferred embodiment of the present invention, a method of packaging an integrated optics chip and of integrating it with its input and output optical fibers, using the constructional methods described above with wafer level packaging or flip chip technology. Reference is now made to FIG. 22, which schematically shows a preferred method of achieving this aspect of the invention. In this method the fiber 580 is placed above the root of the waveguide 530, which is isolated from the substrate 550 by means of a silicon dioxide buffer layer 540. A collimator 590 is positioned at the bottom of the fiber. The fiber is held in position by placing it inside a hole formed inside the top silicon wafer 560, which is also used to encapsulate the device substrate wafer 550, using known technologies such as flip-chip or wafer level packaging. In this case, the device is preferably sealed by using indium bumps 570. Such hole and fiber placements are readily feasible using current DRIE processes. As is seen in FIG. 22, the hole does not need to reach the bottom, as silicon is transparent for use with wavelengths in the range between 1.3 μm and 1.6 μm. For other wavelengths, a thin layer of a transparent material may preferably be deposited on the back of the top wafer prior to the deep etch. A coupling grating 600 may preferably be formed on top the waveguide 530, such that light emitted by the fiber is redirect into the waveguide 530. Such grating couplers with coupling efficiencies of better than 95% have been described by R. M. Emmons et al., in the article “Buried-oxide silicon-on-insulator structures II: Waveguide grating couplers,” published in IEEE Quantum Electronics, Vol. 28, No. 1, pp. 164-175, 1999.

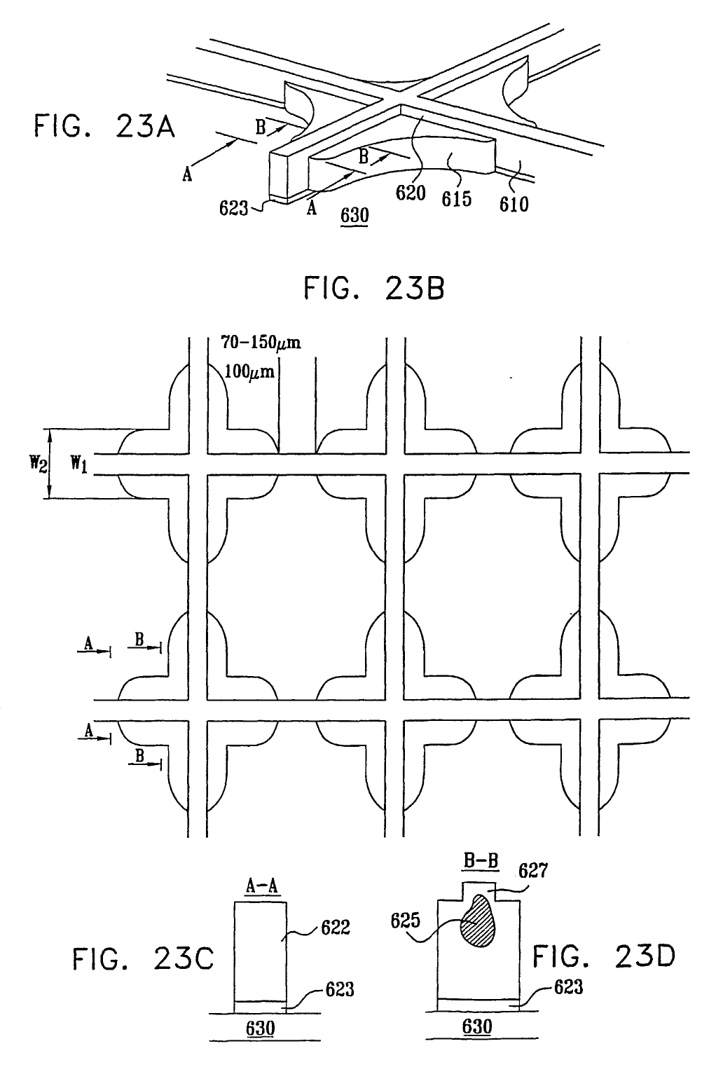

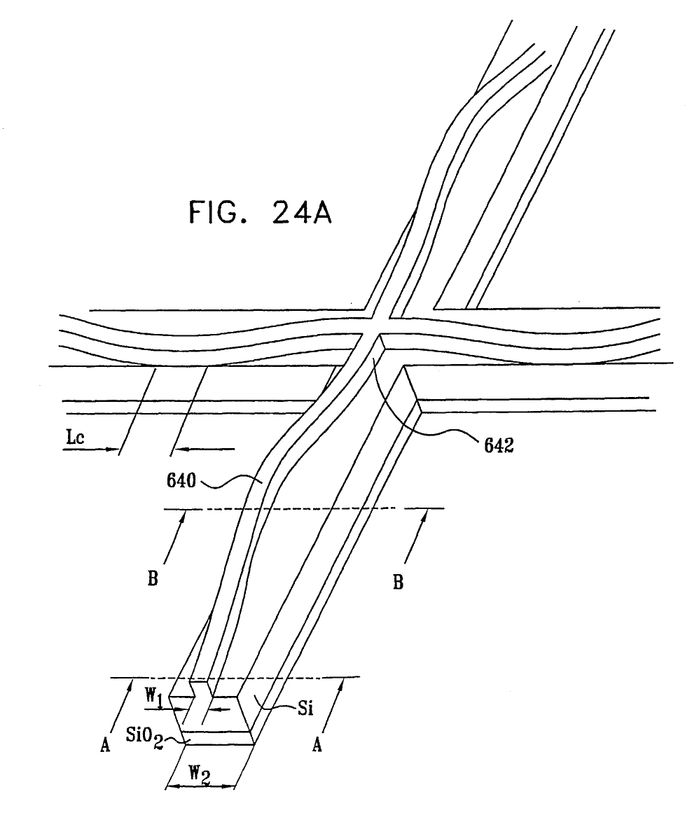

Reference is now made to FIGS. 23A to 23D, which are schematic drawings of an alternative method of constructing a switching network, according to another preferred embodiment of the present invention. In this embodiment, use is made of ribbed waveguide, which has a large propagation cross section, thus reducing losses, but supports only the fundamental mode. The use of ribbed waveguide also reduces leakage losses at the crossovers. The leakage shown in the simulation of the normal waveguide crossover shown in FIG. 17, is a result of the sudden change in refractive index seen by the propagating light signal when it is perturbed at the crossover by the presence of the medium outside the waveguide. The use of ribbed waveguide reduces this loss by concentrating the regions of highest field intensity below the rib, as shown hereinbelow in FIG. 23D. In this position, the highest field intensity is distanced from the crossover, and so does not experience the losses due to the crossover to such an extent as normal waveguide.

FIG. 23A is an illustration of a single crossover, showing how the normal waveguide 610 is converted by means of an adiabatic transition 615 into a ribbed waveguide at the crossover itself. The lines A-A and B-B define planes of cross sections of the transition, to illustrate the construction and operation of this preferred embodiment more clearly. FIG. 23B is a schematic plan view of a complete 2×3 network built using ribbed waveguide, showing the typical dimensions of such a network. The length of normal waveguide between two adiabatic sections is preferably 50 to 150 μm, while the length of an adiabatic section is preferably 100 μm. The width W1 of the normal waveguide is preferably 2 μm, while that of the adiabatic section W2 is 10 μm. FIG. 23C is a cross sectional view of the normal waveguide at plane A-A, showing the silicon waveguide 622 sitting on top of the SiO₂ layer 623 isolating it from the silicon substrate beneath 630. FIG. 23D is a cross-sectional view of the ribbed waveguide, showing how the maximum field intensity of the mode 625 moves down away from the rib, leaving a low field intensity in the rib itself 627.

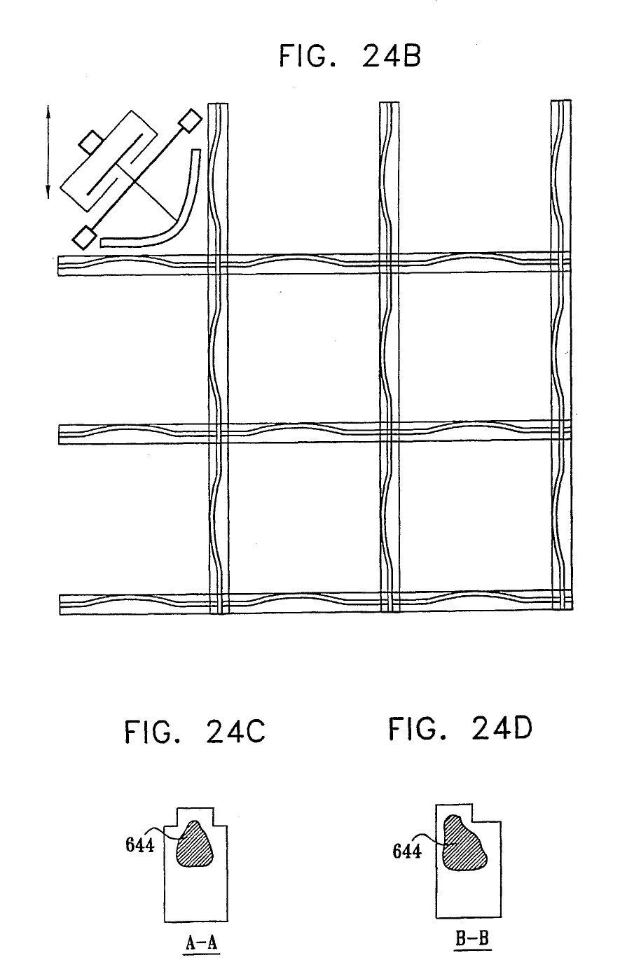

Reference is now made to FIGS. 24A to 24D, which are schematic drawings of an alternative method of constructing a switching network, according to yet another preferred embodiment of the present invention. In this embodiment, use is made of a ribbed waveguide, like that shown in FIGS. 23A to 23D, to reduce losses at the crossover itself. Unlike the embodiments shown in FIGS. 23A to 23D, where the rib is absent at the points of couplings, and the coupling is done between normal waveguides, in the embodiments of FIGS. 24A to 24D, the rib is kept for the entire switch path, but is diverted to the side of the waveguide in the region where the coupler makes contact with the waveguide. This diversion concentrates the field intensity in the region of the coupler contact, thus increasing coupling efficiency. The position of the rib thus wanders over the waveguide surface to provide low losses at the crossover, and high efficiency at the coupler contact.

FIG. 24A is an illustration of a single crossover and coupling region, showing how the waveguide rib 640 is close to the coupling wall where the coupler contacts it, and moves to the center of the waveguide 642 at the crossover. The lines A-A and B-B define planes of cross sections of the transition, to illustrate the construction and operation of this preferred embodiment more clearly. The dimensions W1 and W2 have values similar to those shown in the embodiment of FIG. 23B. FIG. 24B is a schematic plan view of a complete 3×3 network built using “wandering rib” waveguide. FIG. 24C is a cross-sectional view of the centrally ribbed waveguide at plane A-A. The maximum field intensity 644 of the mode is centrally located under the rib. FIG. 23D is a cross-sectional view of the ribbed waveguide at plane B-B, showing how the maximum field intensity of the mode 646 has moved with the rib to the side of the waveguide, to the region where the coupler makes contact with the waveguide.

In the method of construction of the optical crossovers shown in FIG. 18D, the crossing switch waveguides are constructed to be located in different layers, such that the losses at the crossover are reduced. However, although the embodiment shown achieves low losses at the single crossover shown, at the next crossing of the vertical waveguide with a horizontal waveguide, the signal in the lower layer of the vertical waveguide crosses the lower layer of the next horizontal layer, with the concomitant losses at such a crossover. Therefore, the embodiment shown in FIG. 18D is only successful in reducing losses at the actively switched crossover, but not at any successive crossovers in the path of the signals.

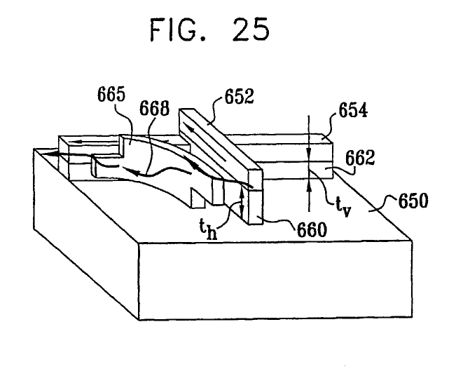

Reference is now made to FIG. 25, which is a schematic diagram of another method of optical switch construction, according to another preferred embodiment of the present invention, which ensures that the losses at the optical waveguide crossover are reduced at all the crossovers in the network. The switch is constructed on a silicon substrate 650, and like the previously described embodiments, has a horizontal waveguide 652, and a vertical waveguide 654. Unlike the previous embodiment of FIG. 18D, each waveguide is constructed of only one layer of Si on SiO₂. The horizontal waveguide has a thick layer of SO₂ 660, of thickness tₕ, while the vertical waveguide has a thinner layer of SiO₂ 662, of thickness tᵥ., where tₕ>tᵥ. As a result of the different thicknesses of SiO₂ base layer, at the crossover, the Si waveguide layer of the upper waveguide passes clearly over the Si waveguide layer of the vertical waveguide, while the Si waveguide layer of the vertical waveguide passes through the SiO₂ base layer of the horizontal waveguide. The crossing layers of Si are thus kept quite separate, leading to effectively zero cross talk, and very low losses.

The architecture of the coupler waveguide 665 in this preferred embodiment of the switch is designed to couple the light from the top waveguide to the lower waveguide entirely by means of mode coupling. The coupling to and from the coupler waveguide is performed by mode coupling, as in all of the previous embodiments of this invention. The waveguide coupler is constructed entirely of Si, and has a shape such that the light within it is transferred by means of mode coupling 668, from its top region, where it entered by mode coupling with the horizontal waveguide, to its lower region, where it will leave by mode coupling with the vertical waveguide.

In addition to the switching networks which can be constructed using the switching element of the present invention, such switching elements can be used in the implementation of a number of other applications and optical circuits, according to further preferred embodiments of the present invention.

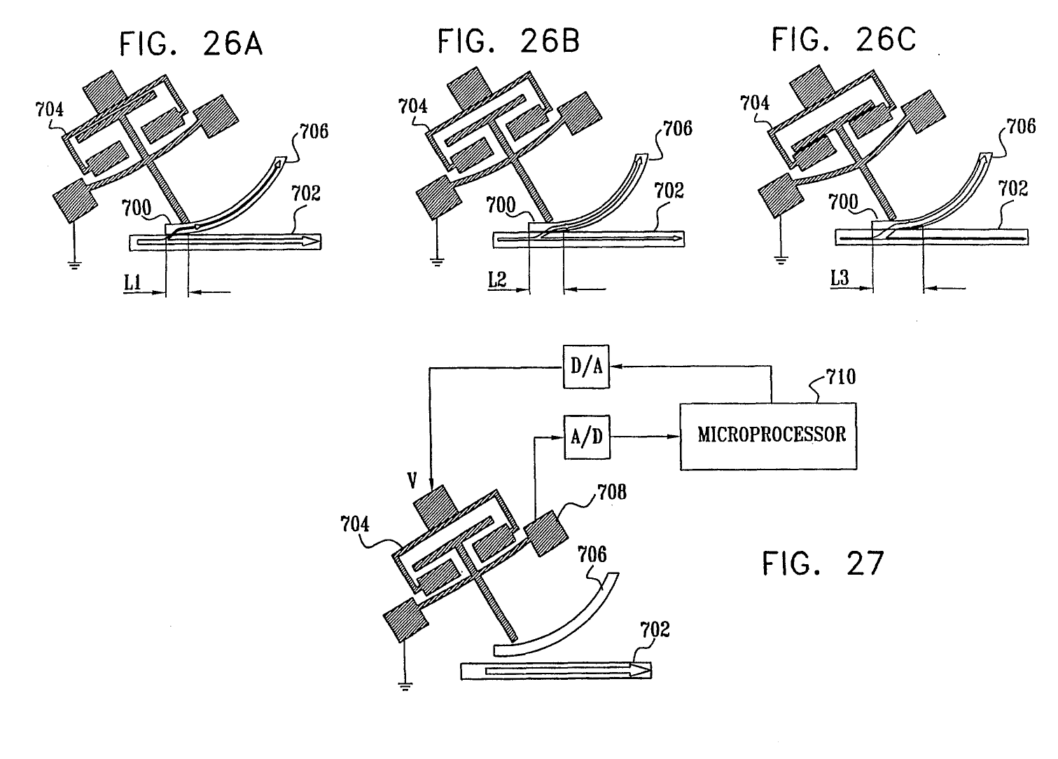

Reference is now made to FIGS. 26A to 26C, which are schematic drawings of a controlled coupling element, based on a variation of the single switch embodiment shown in FIGS. 9A and 9B above. As can be seen in FIGS. 9A and 9B, in the region of coupling, the coupling waveguide is straight and is moved in parallel to the bone waveguide in order to allow full energy transfer between the waveguides. According to another preferred embodiment of the present invention, by amending the coupling mechanism, it becomes possible to tune the coupling efficiency and therefore allow controlled energy transfer between the bone waveguide and the coupled waveguide. In FIG. 26A, it is observed that the coupler 700 has an initial angle relative to the bone (horizontal) waveguide 702. Therefore, by applying different levels of displacement by means of the actuator mechanism 704, different coupling lengths can be chosen. In FIG. 26A, a small displacement is generated, resulting in a short coupling length L1, and a small level of energy transfer, as indicated by the thin line representing the coupled-out light intensity. In FIG. 26B, the displacement is larger, resulting in a longer coupling length L2, and a larger coupled output, and in FIG. 26C, an even larger output resulting from an even longer coupling length L3.

Reference is now made to FIG. 27, which is a representation of a complete automated optical attenuator system, based on the variable coupling element described in FIGS. 26A to 26C. The position of the actuator 704 is determined by means of a sensor—708, such as is disclosed in U.S. Pat. No. 6,128,961 for “Micro-electro-mechanics systems (MEMS)” to the present inventor. The movement of the actuator is fed back to a microprocessor 710, where the measured value is compared with a preselected value and a correction signal sent to the actuator driver to bring the coupling length to its required value, and hence the attenuation to the desired level.

According to yet another preferred embodiment of the present invention, the above described variable coupler can be used to compensate for variations in the insertion losses for different path lengths through a switch network, such as that described in the embodiment of FIG. 10A above. Light signals from different input fibers traverse different paths in the switching network. The light signals thus accumulate different levels of losses in these different paths, which may be problematic in some applications. The variable attenuators described in FIGS. 26A to 26D can thus be used to control the losses, such that they are uniform across the entire network, by reducing the coupling length along the longest, and hence, the most lossy paths. Since the losses in each path are known, in fact there is no need for tunability, but each switch can have a predetermined level of coupling adjusted to compensate for the loss in the path which it switches.

The coupling element embodiment described above can also be utilized in multicasting applications. Given information is divided into several channels by this means. One application of such a system is in information security. Part of the information being transmitted is channeled into a separate path for use as a backup in case there is a problem in the main path and information is lost. This security division is, however, at the expense of the amplitude of the information signals.

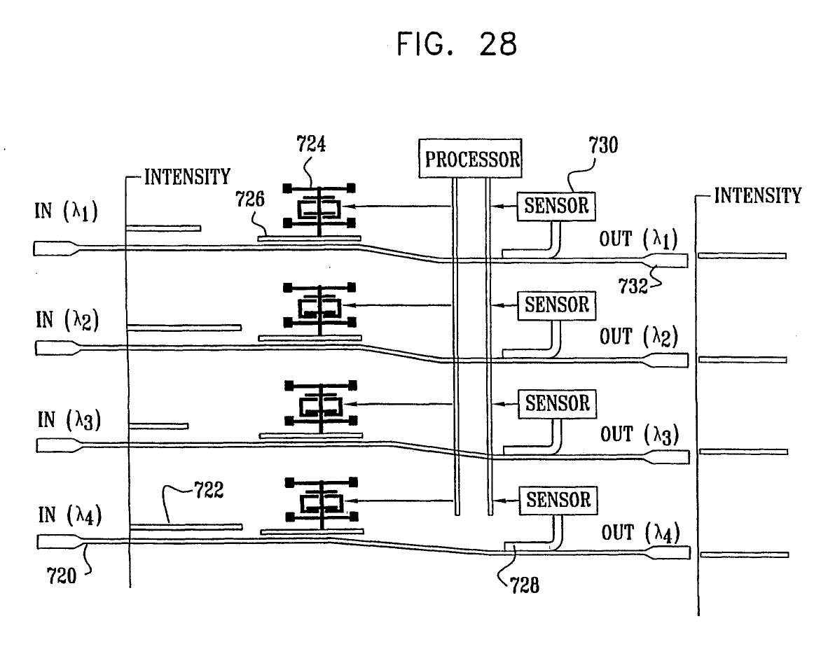

Reference is now made to FIG. 28, which illustrates schematically an optical gain equalizing system, constructed and operative according to another preferred embodiment of the present invention. In such a gain equalizer, variable optical attenuators are used for equalization of the optical intensities in different channels. Such equalization is very important in optical communication systems, for power budget management. After multi-channel amplification, for example, since the amplifiers generally have a wavelength dependence, the system output from the amplifier system generally has a non-uniform amplitude distribution as a function of wavelength, and a gain equalizer is used for bringing all the amplitudes back to the same level. In FIG. 28, the input optical signals 720 are all seen to be of different intensity 722. A variable optical attenuator 724, preferably of the type described in FIG. 27, and incorporating a suspended coupler 726, is disposed in every channel. Downstream of this coupler, a small fixed percentage of the intensity inside each channel is sampled by means of a fixed coupler 728, and the level determined by the sensor attached 730. The sensor 730 outputs a feedback signal that is proportional to the intensity in the main line. This feedback signal is input to a microprocessor 732, which in turn controls the suspended coupler 726, which controls the level of attenuation inserted into the line. The suspended coupler can preferably operate either on the basis of control of the energy coupled out by means of the pressure on the coupler, or by means of control of the distance between the coupler waveguide and the main line, or by means of the coupling length induced. The microprocessor controls the actuators in such a way as to equalize the intensities of the outputs 732 in each channel.

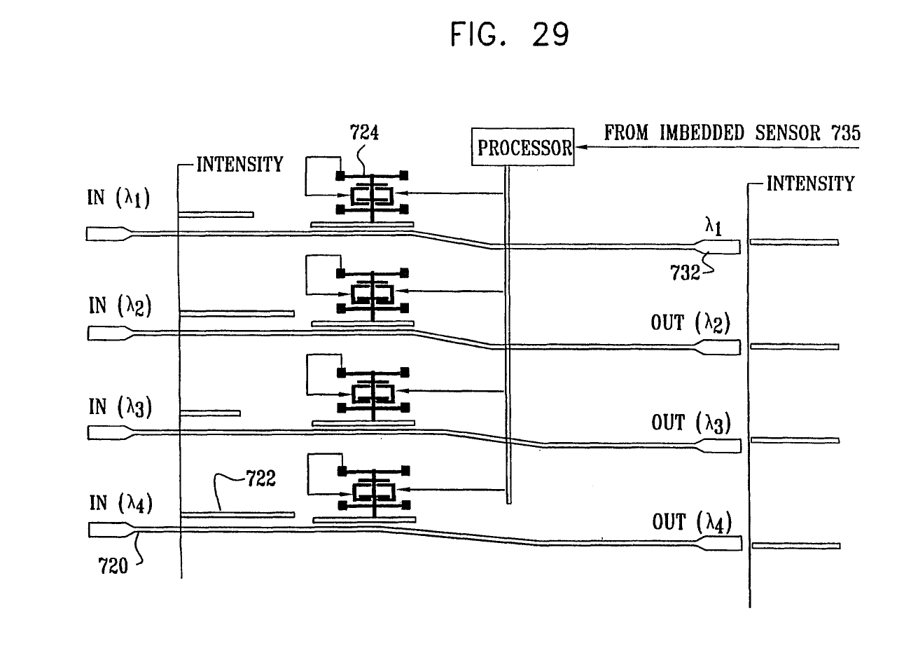

Alternatively and preferably, as shown in the embodiment of FIG. 29, the level sensor need not be built into the output line of the gain equalizer, but may preferably be remotely installed, such as, for instance, at the far end of a communications line. In such a case, the correction signal provided 735 to the gain equalizer is such as to ensure that the signals arriving at their destination, after transmission down the link, will all have a similar level, regardless of any wavelength dependent loss mechanisms active along the length of the link.

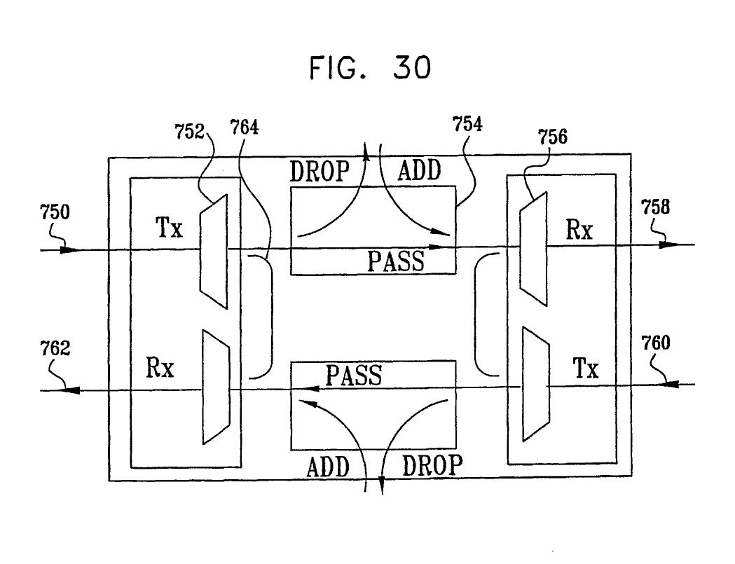

Reference is now made to FIG. 30, which illustrates schematically an optical Wavelength Add and Drop (WAD) system, constructed and operative according to another preferred embodiment of the present invention. Optical communication systems use multiple wavelengths to carry information in a single fiber. One of the requirements of such a system is to drop information contained in packets at one or more wavelengths at a specific station, and to add other information at one or more wavelengths to the data stream. This application is called Wavelength Add and Drop (WAD). In currently used systems, thin film technology is commonly used to perform these functions. The current state of this technology limits it to a small number of WAD channels, as a higher number of channels compromises the performance of the entire system. Moreover, thin film technology allows only the selection of fixed channels without tunability. Future WAD systems will require large number of channels, with as many as 80 currently envisaged, and with tunability. One currently pursued approach to provide this requirement is based on a one-dimensional array of micro-mirrors, each mirror either passing the impinging light or dropping it. This approach is ultimately based on bulk optics components, and is not therefore been overly successful commercially.

In the configuration shown in FIG. 30, which is of a two-way WAD system, the multi-wavelength input signals entering at the input port 750, are multiplexed by means of the Wavelength Division Multiplexer 752, from which a single channel output is shown proceeding to the Drop and Add module 754. It is to be understood, however, that the multiplexer 752 outputs a large number of channels, depending on the wavelength division performed, and that FIG. 30, for clarity, shows only one of these many channels. The Add or Drop signals are added or dropped at the Add and Drop module 754 as required, and the Pass signal continues to a demultiplexer 756, where it is combined with the signals from the Add and Drop modules from the other Wavelength Divided channels, and the combined signal outputs the WAD system at the output port 758, and continues down the communication system fiber. The two-way WAD system has a similar arrangement for the return signal fiber, shown entering the system at input port 760 and leaving at port 762. A loop 764, connected by directional couplers between the forward and return fibers, is used at each input for testing the system.

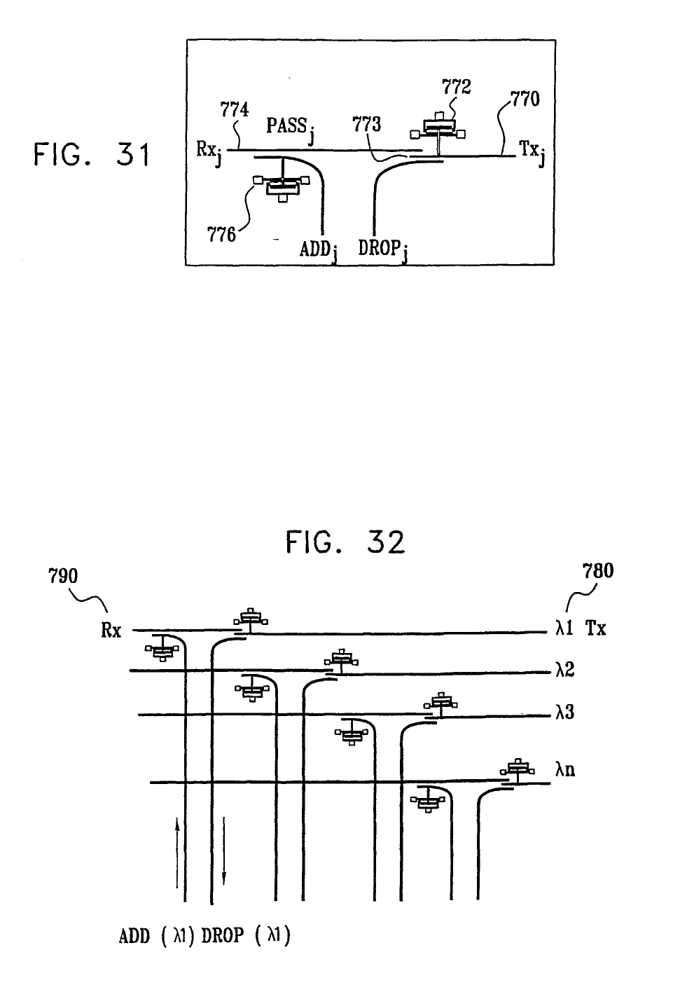

Reference is now made to FIG. 31, which shows the implementation of the Add and Drop module 754 shown in FIG. 30, constructed and operative according to another preferred embodiment of the present invention, using optical switches based on the coupler and-micro-actuator mechanisms shown in FIGS. 9A and 9B. The input signal 770 is passed to an optical switch 772, where it is switched according to requirements, by bending of the coupler waveguide 773, either to the waveguide leading to the Drop port, or to the waveguide leading to the Pass line. A second optical switch 776 is located in the Pass line, and is switchable to add signals entering the module at the Add port, according to requirements. From the Pass line, the signal exits the Add and Drop module at port 774. The elements are all suffixed j, to represent the j^{th} module of an array of such modules in the WAD system.

Reference is now made to FIG. 32, which shows part of a complete multichannel WAD system, constructed and operative according to another preferred embodiment of the present invention, utilizing the Add and Drop modules shown in FIG. 31. Each of the separate input channels 780 carries its own wavelength signals, marked λ1, λ2, λ3 . . . λn. Each of these channels has an Add and Drop module, preferably constructed using the waveguide couplers and micro-actuator architecture shown in FIG. 31. By way of example, the λ1 channel of the system of FIG. 32 is shown adding and dropping signals, before exiting at the output port 790.

The use of the optical switches and microactuators, according to preferred embodiments of the present invention, enables an on-chip multichannel WAD system to be constructed with losses per channel in the range of 6 db. The overall dimensions of the WAD system can be made similar to those of standard VLSI chips. By using standard VLSI fabrication tools, mass production of such WAD systems becomes feasible, similar to that common in the VLSI industry.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

We claim:

1. An optical switching device comprising;
a planar substrate;
at least a first and a second waveguide associated with said substrate; and
a coupling medium, which, when activated, creates an optical path parallel to the plane of said substrate, such that at least part of light propagating along said first waveguide is coupled into said second waveguide.

2. An optical switching device according to claim 1, wherein said first and said second waveguides cross each other.

3. An optical switching device according to claim 2, wherein said first and said second waveguides cross each other on different planes.

4. An optical switching device according to claim 3, wherein each of said different planes comprises one of said waveguides and an associated insulating layer, said insulating layer being operative to separate said waveguides.

5. An optical switching device according to claim 3, wherein said different planes are formed by means of insulating layers of different heights beneath said first and said second waveguides.

6. An optical switching device according to claim 5, wherein said coupling medium has extremities and is shaped such that light is transferred by mode coupling from an extremity contacting said first waveguide to an extremity contacting said second waveguide.

7. An optical switching device according to claim 6, wherein said coupling medium creates an optical path between said waveguides at different planes.

8. An optical switching device according to claim 4, wherein said waveguides are formed by patterning and etching technologies.

9. An optical switching device according to claim 4, wherein said waveguide comprises a material selected from a group consisting of silicon, gallium arsenide, gallium nitride, III-V compounds, lithium niobate, silica, and a polymer.

10. An optical switching device according to claim 4, wherein said insulating layer comprises a material selected from a group consisting of silicon dioxide, silicon nitride, titanium dioxide and a polymer.

11. An optical switching device according to claim 4, wherein said insulating layer has an index of refraction smaller than that of said waveguide material.

12. An optical switching device according to claim 1, wherein said coupling medium is a suspended coupling waveguide, and said optical path is created by movement of said suspended waveguide towards said first and second waveguides, such that mode coupling occurs between said first waveguide and said coupling waveguide and between said coupling waveguide and said second wave guide.

13. An optical switching device according to claim 12, wherein said movement of said suspended waveguide towards said first and second waveguides is such that contact is made between said coupling waveguide and said first and second waveguides.

14. An optical switching device according to either of claims 12 and 13, and also comprising an actuator operative to move said coupling waveguide.

15. An optical switching device according to either of claims 12 and 13, wherein said first and said second waveguides cross each other.

16. An optical switching device according to claim 15, wherein said first and said second waveguides cross each other on different planes, such that interaction between them is reduced.

17. An optical switching device according to claim 16, wherein each of said different planes comprises one of said waveguides and an associated insulating layer, said insulating layer being operative to separate said waveguides.

18. An optical switching device according to claim 16, wherein said different planes are formed by means of insulating layers of different heights beneath said first and said second waveguides.

19. An optical switching device according to claim 18, wherein said coupling medium has extremities and is shaped such that light is transferred by mode coupling from an extremity contacting said first waveguide to an extremity contacting said second-waveguide.

20. An optical switching device according to claim 19, wherein said coupling medium creates an optical path between said waveguides at different planes.

21. An optical switching device according to claim 17, wherein said waveguides are formed by patterning and etching technologies.

22. An optical switching device according to claim 17, wherein said waveguide comprises a material selected from a group consisting of silicon, gallium arsenide, gallium nitride, III-V compounds, lithium niobate, silica, and a polymer.

23. An optical switching device according to claim 17, wherein said insulating layer comprises a material selected from a group consisting of silicon dioxide, silicon nitride, titanium dioxide and a polymer.

24. An optical switching device according to claim 17, wherein said insulating layer has an index of refraction smaller than that of said waveguide material.

25. An optical switching device according to any of the previous claims and wherein optical amplifiers are integrated in said waveguides.

26. An optical switching device according to either of claims 12 and 13, wherein said optical path is modulated by creating a wavelength sensitive coupling grating on said coupling suspended waveguide such that said modulation affects the intensity of said coupled light.

27. An optical switching device according to either of claims 12 and 13, wherein at least one of said first and second waveguides are also suspended, and said optical path is controlled by the bending of at least one of said first and second waveguides and said coupling suspended waveguide.

28. An optical switching device according to either of claims 12 and 13, wherein the geometry of said waveguide in the region of said coupling is predetermined to enhance said coupling.

29. An optical switching device according to either of claims 12 and 13, wherein said suspended coupling waveguide has a higher index of refraction than said first and second waveguides.

30. An optical switching device according to either of claims 2 and 15 wherein said first and said second waveguides are shaped such that a central rib is formed on said waveguides in the region where said waveguides cross each other.

31. An optical switching device according to claim 15, wherein said first and said second waveguides are shaped such that a central rib is formed on said waveguides in the region where said waveguides cross each other, and said rib is diverted to a side of said waveguides in the region where said coupling medium is in contact with said waveguides.

32. An optical switching network comprising:
a first set of waveguides;
a second set of waveguides crossing said first set at an angle; wherein each of set sets of waveguides comprises at least two waveguides; and
at least one coupling medium placed close to the crossing point of one waveguide of said first set of waveguides and one waveguide of said second set of waveguides, such that when said coupling medium is activated, it creates an optical path such that at least part of the light propagating along said one waveguide of said first set of waveguides is coupled into said one waveguide of said second set of waveguides.

33. An optical switching network according to claim 32 wherein the waveguides of said first set of waveguides and the waveguides of said set of waveguides cross each other on different planes

34. An optical switching network according to claim 33, wherein each of said different planes comprises the waveguides of one of said sets of waveguides and an insulating layer, said insulating layer being operative to separate said waveguides where they cross.

35. An optical switching network according to claim 33, wherein said different planes are formed by means of insulating layers of different heights located beneath said waveguides of said first and said second sets of waveguides at their crossing point.

36. An optical switching network according to claim 34, wherein said waveguides are formed by patterning and etching technologies.

37. An optical switching network according to claim 34, wherein said waveguides comprise a material selected from a group consisting of silicon, gallium arsenide, gallium nitride, III-V compounds, lithium niobate, silica, and a polymer.

38. An optical switching network according to claim 34, wherein said insulating layer comprises a material selected from a group consisting of silicon dioxide, silicon nitride, titanium dioxide and a polymer.

39. An optical switching network according to claim 34, wherein said insulating layer has an index of refraction smaller than that of said waveguide material.

40. An optical switching network according to any of the previous claims to 32 to 39 and wherein optical amplifiers are integrated in said waveguides.

41. An optical switching network according to claim 32, wherein said at least one coupling medium is a suspended coupling waveguide, and said optical path is created by movement of said suspended waveguide towards said one waveguide of said first set of waveguides and said one waveguide of said second set of waveguides, such that mode coupling occurs between said one waveguide of said first set of waveguides and said coupling waveguide, and between said coupling waveguide and said one waveguide of said second set of waveguides.

42. An optical switching network according to claim 41, wherein said movement of said suspended waveguide towards said one waveguide of said first set of waveguides and said one waveguide of said second set of waveguides is such that contact is made between said coupling waveguide and said one waveguide of said first set of waveguides and said one waveguide of said second set of waveguides.

43. An optical switching network according to claim 41 wherein the waveguides of said first set of waveguides and the waveguides of said set of waveguides cross each other on different planes

44. An optical switching network according to claim 43, wherein each of said different planes comprises the waveguides of one of said sets of waveguides and an insulating layer, said insulating layer being operative to separate said waveguides where they cross.

45. An optical switching network according to claim 43, wherein said different planes are formed by means of insulating layers of different heights located beneath said waveguides of said first and said second sets of waveguides at their crossing point.

46. An optical switching network according to claim 44, wherein said waveguides are formed by patterning and etching technologies.

47. An optical switching network according to claim 44, wherein said waveguides comprise a material selected from a group consisting of silicon gallium arsenide, gallium nitride, III-V compounds, lithium niobate, silica, and a polymer.

48. An optical switching network according to claim 44, wherein said insulating layer comprises a material selected from a group consisting of silicon dioxide, silicon nitride, titanium dioxide and a polymer.

49. An optical switching network according to claim 44, wherein said insulating layer has an index of refraction smaller than that of said waveguide material.

50. An optical switching network according to any of the previous claims 42 to 49 and wherein optical amplifiers are integrated in said waveguides.

51. An optical add and drop module, comprising:
an input port;
an output port;
a port for adding information signals to said output port;
a port for dropping information signals from said input port; wherein said adding and dropping of information signals is performed by an optical switching device according to any of claims 1 to 31.

52. An optical add and drop multiplexer, comprising a plurality of channels each channel adapted to convey light of a different wavelength, at least one of said channels comprising an optical add and drop module according to claim 51.

53. A method of enhancing roughness quality of a reactive ion etched side wall, comprising the steps of:
oxidizing said side wall to create an oxidized layer; and
selective etching of said oxidized layer.

54. A method of enhancing roughness quality of a reactive ion etched side wall, comprising the step of performing a subsequent wet etching process.

55. A method of enhancing roughness quality of the surface of contacting side walls, comprising the step of repeatedly closing said contacting side walls at a high repetition rate such that said surface becomes smoothed by said repeated closing.
